(19) United States
(12) Patent Application Publication
(10) Pub. No.: US 2016/0005047 A1
(43) Pub. Date: Jan. 7, 2016

(54) APPARATUSES, METHODS AND SYSTEMS FOR A HEALTH/WELLNESS ADVERTISING, FINANCING AND MANAGEMENT PLATFORM

(71) Applicant: CBS ECOMEDIA, INC., Manhattan Beach, CA (US)

(72) Inventor: Paul Anthony Polizzotto, Rancho Palos Verdes, CA (US)

(21) Appl. No.: 14/852,444

(22) Filed: Sep. 11, 2015

Related U.S. Application Data
(63) Continuation of application No. 13/442,590, filed on Apr. 9, 2012, now abandoned.
Application No. 13/442,590 is a continuation-in-part of application No. 13/078,851, filed on Apr. 1, 2011, now abandoned.
Application No. 13/078,851 is a continuation-in-part of application No. 12/973,826, filed on Dec. 20, 2010, now abandoned.
(60) Provisional application No. 61/378,915, filed on Aug. 31, 2010.

(51) Int. Cl. G06Q 30/00

(52) U.S. Cl. CPC G06Q 30/00

(57) ABSTRACT

Wellness project application data for a wellness project may be obtained. The wellness project may be approved by a wellness facilitator and may be matched with an advertisement. A payment may be obtained from an advertiser associated with the advertisement and the obtained payment may be used to provide funding for the wellness project. The results of the wellness project may be verified at various stages of the wellness project, and funding for a project or associated fulfillment partner may be rejected or discontinued if the results are not verified.

### RELATED APPLICATIONS

This is a Continuation of U.S. patent application Ser. No. 13/442,590, filed Apr. 9, 2012, entitled APPARATUSES, METHODS AND SYSTEMS FOR A HEALTH/WELLNESS ADVERTISING, FINANCING AND MANAGEMENT PLATFORM, which is a Continuation-In-Part of U.S. patent application Ser. No. 13/078,851, filed Apr. 1, 2011, entitled “APPARATUSES, METHODS AND SYSTEMS FOR MATCHING ENVIRONMENTAL ADVERTISEMENTS WITH ENVIRONMENTAL PROJECTS,” attorney docket no. 0198.ECOM.US.CIP|21089-010US3CP1, to which priority under 35 U.S.C. §120 is claimed, and which is a Continuation-In-Part of U.S. patent application Ser. No. 12/973,826, filed Dec. 20, 2010, entitled, “APPARATUSES, METHODS AND SYSTEMS FOR MOBILE DEVICE-BASED ENVIRONMENTAL ADVERTISING,” attorney docket No. 0198.ECOM.US.ORG3|21089-010US3, which in turn claims priority to U.S. provisional patent application Ser. No. 61/378,915 filed Aug. 31, 2010, entitled “APPARATUSES, METHODS AND SYSTEMS FOR AN ENVIRONMENTAL ADVERTISING, FINANCING AND MANAGEMENT PLATFORM,” attorney docket no. 0198.ECOM.US.PRO1|21089-010PV1.

The aforementioned applications are herein expressly incorporated by reference in their entirety.

### FIELD

The present innovations are directed generally to funding wellness projects, and more particularly, to APPARATUSES, METHODS AND SYSTEMS FOR A HEALTH/WELLNESS ADVERTISING, FINANCING AND MANAGEMENT PLATFORM.

### BACKGROUND

Wellness organizations strive to find ways to improve overall health and wellness of our communities. Advertisers may place ads through advertising networks including broadcast radio/television and more recently, via the Internet. The costs to run advertising vary depending on the complexity of production, the outlet used, and the timing and frequency of placement. Implementing the disclosed methods and systems would benefit advertisers, advertising networks and the public.

### BRIEF DESCRIPTION OF THE DRAWINGS

The accompanying appendices and/or drawings illustrate various non-limiting, example, innovative aspects in accordance with the present descriptions:

FIG. 1 shows an exemplary usage scenario in one embodiment of the WELLNESS AD PLATFORM;

FIG. 2 shows a screen shot diagram illustrating a WellnessAd kiosk in one embodiment of the WELLNESS AD PLATFORM;

FIG. 3 shows a screen shot diagram illustrating a WellnessAd application in one embodiment of the WELLNESS AD PLATFORM;

FIG. 4 shows a screen shot diagram illustrating a WellnessAd barcode application in one embodiment of the WELLNESS AD PLATFORM;

FIG. 5 shows a data flow diagram in one embodiment of the WELLNESS AD PLATFORM;

FIG. 6 shows a logic flow diagram in one embodiment of the WELLNESS AD PLATFORM;

FIG. 7 shows a logic flow diagram illustrating an advertisement retrieving (AR) component in one embodiment of the WELLNESS AD PLATFORM;

FIG. 8 shows a logic flow diagram illustrating a transaction benefit apportionment (TBA) component in one embodiment of the WELLNESS AD PLATFORM;

FIG. 9 shows a screen shot diagram illustrating a Wellness Project Application in one embodiment of the WELLNESS AD PLATFORM;

FIG. 10 shows a logic flow diagram illustrating a project application approving (PAA) component in one embodiment of the WELLNESS AD PLATFORM;

FIG. 11 shows a logic flow diagram illustrating a project verification (PV) component in one embodiment of the WELLNESS AD PLATFORM;

FIG. 12 shows a screen shot diagram illustrating a WellnessButton Menu/Application in one embodiment of the WELLNESS AD PLATFORM; and

FIG. 13 shows a block diagram illustrating embodiments of a WELLNESS AD PLATFORM controller.

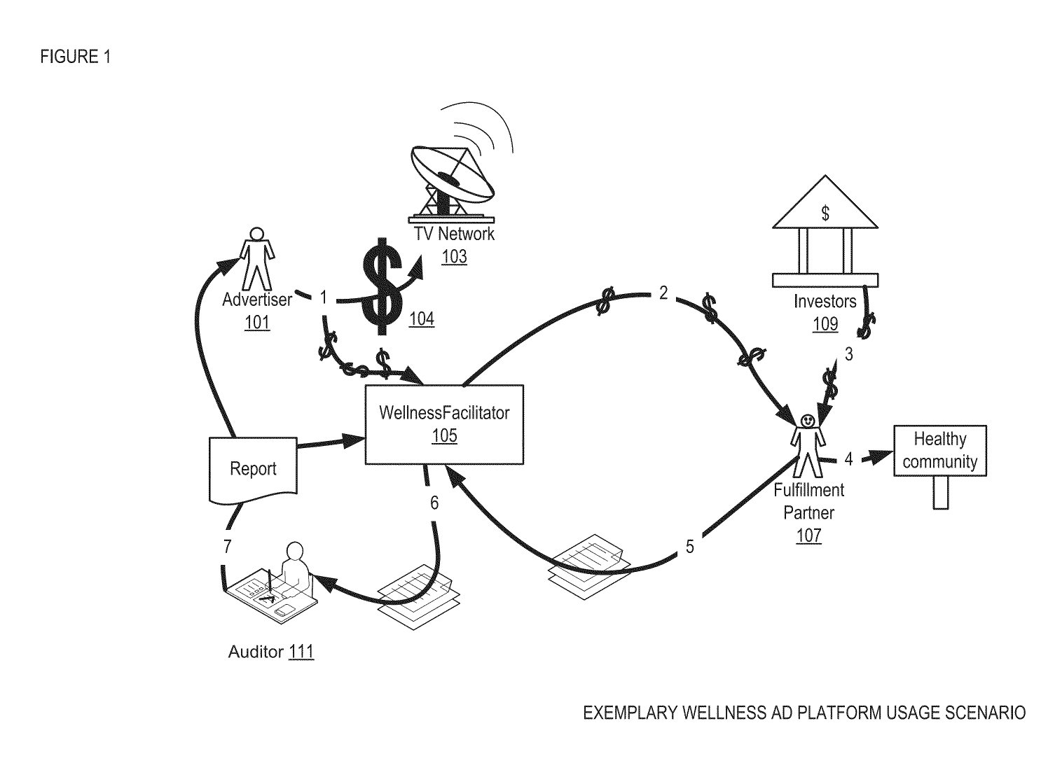

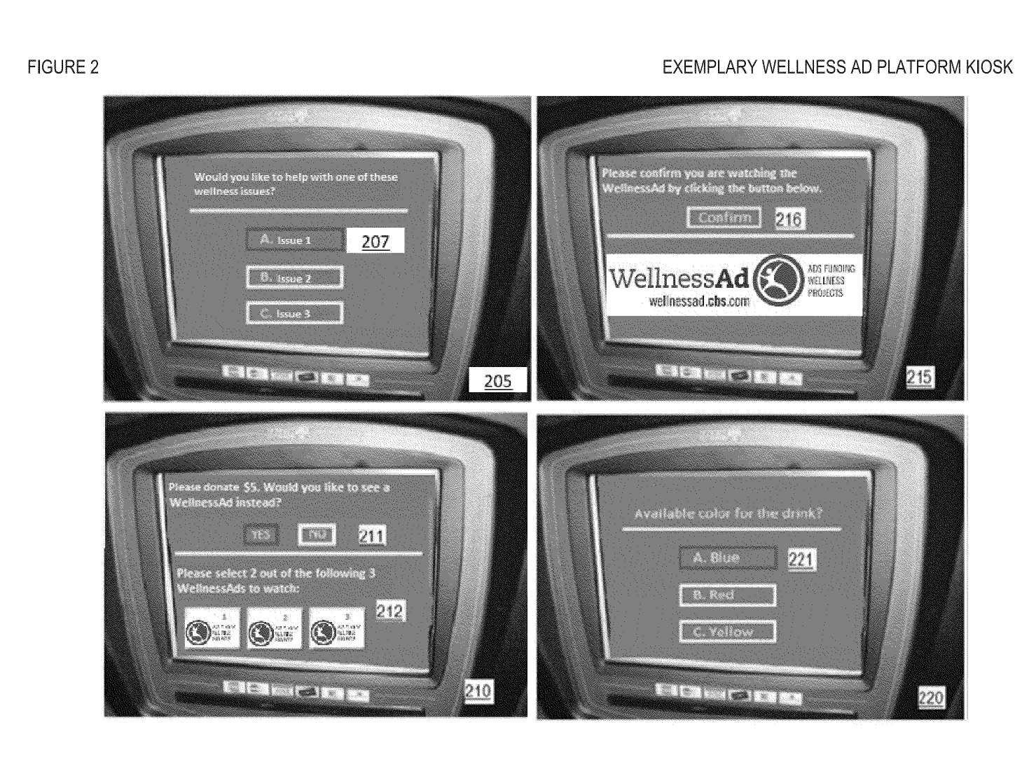

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION

With advertisers and the industries they support becoming increasingly interested in health and wellness issues in the communities they serve, there is a need for new approaches to more effectively link the advertising industry to ways of helping improve the overall health of our communities.

### INTRODUCTION

A WELLNESS AD PLATFORM implements a new type of invested advertising, which helps finance wellness initiatives by investing a portion of collected proceeds from advertisers of certain advertising, such as WellnessAds (sometimes referred to in the figures as WellAds), into predefined wellness projects to obtain positive wellness impact, to create jobs, to increase government revenues, and to generate Credits (e.g., money, WellnessAd application credits, or the like that may be donated by WellnessAd consumers to various beneficiaries). Such advertising creating positive health and wellness impact, when, for example, certified by a WELLNESS AD PLATFORM, may be branded as WellnessAds (and the term is used in that sense herein). The health of our communities could greatly benefit from a variety of wellness projects (e.g., mobile health clinics, early detection and testing for diseases and conditions such as diabetes, obesity and cardiovascular disease, free exercise areas, free exercise classes, better prenatal care, healthier meals, better healthcare infrastructure, or the like). Although such projects would benefit both the local population and the world community by increasing the overall health of the community, unfortunately, many such wellness projects are never implemented due to lack of funding. While partial funding may be available for a wellness project (e.g., from a local government), unavailability of sufficient funding often prevents investors and others from fully capitalizing the project. Timing considerations also play a role, as do problems relating to getting the last few percent of the total cost of a project. Experience has shown that projects requiring defined partial funding which would not be completed absent such funding (frequently called “last mile” or gap funding) are capable of being identified, pre-defined for solution and funded.

The WELLNESS AD PLATFORM helps finance such wellness projects by providing an opportunity for advertisers to use a portion of their advertising budget to provide partial funding for wellness projects of interest to the advertiser or to the advertiser's customers. Using the WELLNESS AD PLATFORM the organizers (e.g., fulfillment partners) of a wellness project may submit a project application to a WellnessFacilitator (or wellness facilitator) describing the wellness project for consideration to become a funded WellnessProject. Using the information provided in the project application, the WellnessFacilitator may work with advertisers to select and fund projects of interest that would otherwise be unfunded. For example, the advertiser may choose to support wellness projects in the advertiser's local geographical area, or in the geographical area of the advertiser's customers. In another example, a company may choose to offer a free health clinic for target customers, or support a fitness zone in a low income area for those unable to afford a gym membership. Furthermore, by supporting wellness projects the advertiser may satisfy an initiative set by the advertiser, the advertiser's customers, or the like. Preferably, the WellnessFacilitator may confirm and verify (e.g., internally, via a third party auditor) calculations, standards, methodologies, or the like used by fulfillment partners to ensure that project goals are met, and report back to the advertiser, preferably providing a certification mechanism.

The resulting advertisements (e.g., WellnessAds) are provided through a premium advertisement platform to actually improve community health, and thereby differentiate these advertisements from the traditional advertisements. For example, because advertisers often are willing to pay a certain amount of money for a consumer's attention (e.g., an ad impression), when a viewer watches a WellnessAd, a portion of the advertiser impression payment may go to fund positive health and wellness projects. As such, when a consumer watches or interacts with a WellnessAd, the consumer is actually positively affecting the health of the community by causing the funding of various positive wellness projects. Further, if the consumer were to be able to choose between a traditional advertisement and a WellnessAd, a consumer could have a preference toward the WellnessAd.

Also, once the WellnessFacilitator pre-identifies and sources the project and provides sufficient funding (likely gap funding) obtained from advertisers for WellnessAds, then a selected positive wellness project may commence. This in turn creates jobs, increases tax revenues, etc. in the locality, and also improves the community's health. The WellnessFacilitator may oversee the wellness project, measure the impact produced by the wellness project, and verify that the wellness project is producing a positive health impact.

### Wellness Ad Platform

The WELLNESS AD PLATFORM facilitates positive wellness impact by a consumer in a variety of ways (e.g., by watching, listening and interacting with a WellnessAd). The WELLNESS AD PLATFORM may provide an opportunity for a user to select beneficiaries (e.g., local wellness projects) of project funding and/or WellnessAd viewing and/or interactions. Although the use of the WELLNESS AD PLATFORM is described mainly from the point of view of an WellnessAd consumer, it is to be understood that users of the WELLNESS AD PLATFORM may include various entities including a WellnessAd Facilitator, a TV (or other) Network, an advertiser, third party intermediaries (e.g., the owner of a taxi with a WellnessAd kiosk, an airline with WellnessAd enabled seat back media terminals, or the like), WellnessProject organizers, investors, auditors, or other like. The WELLNESS AD PLATFORM may be accessible through a variety of devices and methods (e.g., via a kiosk, via a mobile application, via a website, via broadcast radio/television, or the like).

By watching a WellnessAd, the consumer may benefit not only by learning about an advertisers product, but also by knowing that the consumer is supporting a WellnessProject of interest. For example, using the information provided by WellnessProject organizers in project applications, the consumer may learn about various WellnessAds benefiting certain WellnessProjects; consumers may select a WellnessAd/WellnessProject that they care about (e.g., a local fitness zone building project). Furthermore, consumers may be provided an opportunity to show additional support for the WellnessProject by providing confirmation that the consumer watched and comprehended the WellnessAd. Consumer interactions with WellnessAds may provide benefits to a number of beneficiaries, some of which may further support wellness projects. In addition to providing information to the consumer regarding an advertisers product, a WellnessAd may provide information regarding the WellnessProject supported by the WellnessAd. For example, the WellnessAd may describe whether the WellnessProject is fully funded; if not, how much money needs to be generated for the WellnessProject to be fully funded; if the WellnessProject is in progress or has been completed; before and after pictures illustrating the positive wellness impact created by the WellnessProject; etc. Furthermore, a WellnessAd may educate a consumer regarding healthier ways of living, ways to treat or avoid illnesses, or the like. For example, the WellnessAd may educate the consumer regarding the importance of exercise (for heart health, to help treat or prevent obesity, to lower cholesterol, etc.) or where they can find access to fitness zones or free exercise classes. Proceeds generated by consumers watching WellnessAds for the WellnessProject may feed back additional Credits, value, and positive wellness impact; for example, portions of payments from advertisers and any portion of Credits generated from consumers' consumption of WellnessAds (e.g., impressions) may be given to various beneficiaries (e.g., to fund new WellnessProjects, to consumers and their selected friends, to advertisers, etc.).

FIG. 1 shows an exemplary usage scenario in one embodiment of the WELLNESS AD PLATFORM. In FIG. 1, an advertiser 101 provides payment 104 (e.g., $1,000,000) for advertising services to a publisher, such as a TV Network 103, with an understanding that part of the payment (e.g., $100,000) is used to support wellness initiatives via a WellnessFacilitator 105. In various embodiments, the publisher may be a broadcast TV network, a cable TV network, a satellite TV network, a digital content publisher, an audio content publisher, an online or print magazine publisher, etc. In one embodiment, the advertiser may provide payment for advertising services to a TV Network, and the TV Network may transfer part of the revenue to the WellnessFacilitator. In another embodiment, the advertiser may provide one part of the payment to the TV Network (or another publisher) and another part of the payment to the WellnessFacilitator. In yet another embodiment, the advertiser may provide payment to an entity that distributes the payment between the TV Network (or one or more publishers) and the WellnessFacilitator. In return, the advertiser will be able to provide the public with premium branded WellnessAds.

The WellnessFacilitator may support selected WellnessProjects that provide positive wellness impact by providing seed, supplemental, and/or gap funding for the selected WellnessProjects. For example, interested third parties such as a government (e.g., local municipality, city government, county government, state government, federal government, or the like), a local non-profit organization, a wellness organization (e.g., National Wellness Institute, Wellness Councils of America, World Health Organization, Trust for Public Land, or the like) may wish to implement a positive wellness project (e.g., a project to decrease obesity), but may not have enough funds available for the positive wellness project (e.g., a mobile health clinic). The WellnessFacilitator, having received funds from an advertiser, may provide financing for the wellness project and this may, in turn, encourage other investors 109, such as a bank, to provide additional financing for the wellness project. Alternatively, the WellnessFacilitator may pre-identify projects specified by wellness organization for advertiser approval. In various embodiments, funding may be facilitated by a WellnessFacilitator, by interested third parties, through use of B-Notes, or the like. With funding available, the WellnessProject organizer, fulfillment partner 107, may proceed with the wellness project creating jobs and resulting in a positive wellness impact (e.g., a healthy community).

In one embodiment, the government may allow the advertiser to publicize its support for a WellnessProject (e.g., via a sign, billboard, or the like near the site of the project); this may be of particular value in controlled areas where advertisements are otherwise not allowed.

FIG. 2 shows a screen shot diagram illustrating a WellnessAd kiosk in one embodiment of the WELLNESS AD PLATFORM. The WellnessAd kiosk (e.g., provided in a taxi, a train, an airplane, a ship, a stationary Automated Teller Machine (ATM), a doctor's office, or the like) may serve as a delivery mechanism for the WellnessAd via the WELLNESS AD PLATFORM including facilitating consumer support for various wellness issues of interest to consumer (e.g., on a touchscreen monitor in a doctors office, at a wellness clinic, in the back of a taxi cab embedded into the back of the taxi's front seat). Preferably, different advertisement formats and lengths may be made available based on (or related to) the display type and location (e.g., long format advertisements, such as those having duration greater than 30 seconds, may be preferred in kiosks having longer average viewer dwell times, such as airplane or doctor's office kiosks. For example, as illustrated in screen 205, the kiosk may prompt the consumer to help with a wellness issue. The consumer may select a wellness issue of interest (e.g., adding a mobile health clinic to the consumer's neighborhood) 207. In some embodiments, wellness issues available for selection may depend on the location of the consumer. In one implementation, the kiosk may store geographic coordinates of its location (e.g., San Francisco). In another implementation, the kiosk may obtain its geographic coordinates using a global position system (GPS).

The kiosk may prompt the consumer to help (e.g., donate money, watch a WellnessAd) with the selected wellness issue. As illustrated in screen 210, the kiosk may facilitate consumer selection of a payment method 211 (e.g., pay with a credit card or watch a WellnessAd). The kiosk may also retrieve a suitable WellnessAd (e.g., from local memory and/or from a remote database) and display it to the consumer 212. For example, the selection of a suitable WellnessAd to display to the consumer and/or the desired payment method may take into account the location, profile information associated with the consumer, and/or other contextual variables. Consumer profile information may be retrieved from a server via a network connection (e.g., Bluetooth, cellular, WiFi, etc.) based on consumer identifying information provided by using a keyboard, a credit card, an radio-frequency identification (RFID) WellnessAd fob, a smartphone with near field communications (NFC), a facial recognition scanner, a fingerprint scanner, a retinal scanner, and/or the like. Also, the profile information may be stored on and retrieved from the identification device. Such profile information may include the age, sex, nationality, socio-economic status, etc. of the consumer engaged with the WELLNESS PLATFORM. Such information can be aggregated and analyzed to provide even more effective information including WellnessAds to the consumer. In another example, the consumer may explicitly select one or multiple WellnessAds to watch. The WellnessAds from which the consumer may choose may be targeted to the consumer (e.g., as described in the preceding example). As illustrated in screens 215 and 220, the kiosk may also facilitate obtaining confirmation that the consumer watched the WellnessAd (e.g., via a user interface button 216) and/or comprehension of the WellnessAd by the consumer (e.g., by recording the consumer's answer to a multiple-choice question 221). Providing confirmation, comprehension and/or additional profile information may earn the consumer additional Credits and may provide additional funding for a WellnessProject associated with the wellness issue of interest to the consumer.

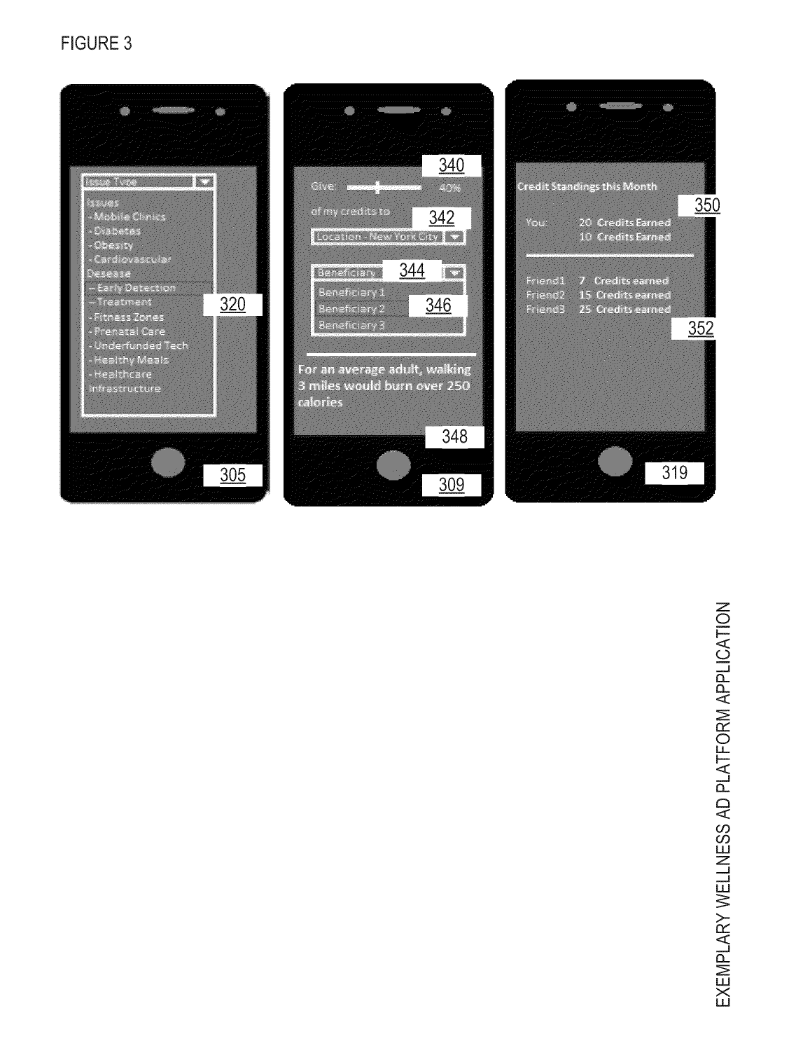

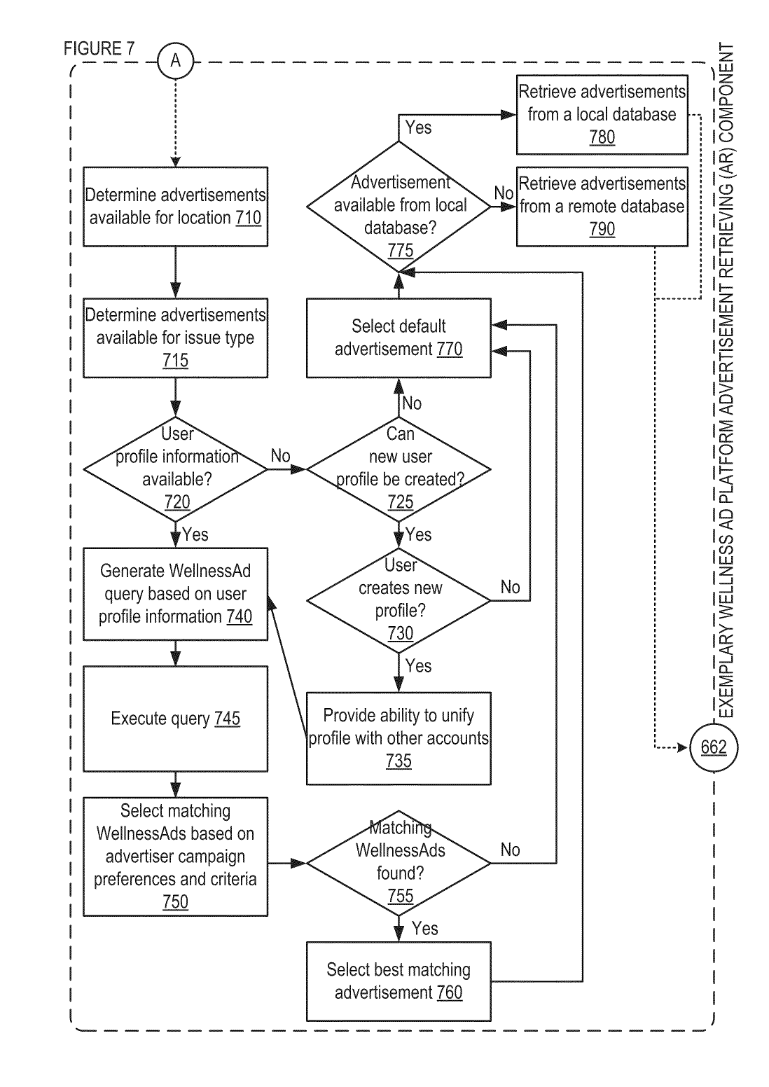

FIG. 3 shows a screen shot diagram illustrating a WellnessAd application on a mobile device in one embodiment of the WELLNESS AD PLATFORM. The WellnessAd application may also be deployed via web-site, desktop application, set-top box, web browser plug-in, and/or the like platforms. In one embodiment, the WellnessAd application is deployed in kiosks, thereby providing even greater flexibility at a kiosk. For example, in places where a WellnessAd kiosk is not available, the consumer may use the mobile WellnessAd application to help with a wellness issue of interest. The WellnessAd application may facilitate inputting information regarding a wellness issue with which the consumer would like to help (e.g., by presenting a user interface allowing the user to select values of select boxes using a touchscreen of a mobile device). For example, such wellness issues may include providing mobile clinics, early detection and/or treatment of diseases and/or conditions such as diabetes, obesity, cardiovascular disease, building fitness zones, providing prenatal care, funding underfunded technologies, providing healthy meals, improving healthcare infrastructure, and/or the like. Upon selection of the activity 320, the WellnessAd application may facilitate consumer selection of a payment method to help with the wellness issue (e.g., pay with a credit card or watch a WellnessAd). The WellnessAd application may also retrieve (e.g., using a MediaLink field of the Advertisement data structure described in more detail in FIG. 7) a suitable (e.g., based on location information obtained via a GPS of the mobile device) WellnessAd (e.g., from local memory, from a remote location via an internet connection, and/or the like) and display it to the consumer. The WellnessAd application may also facilitate obtaining confirmation that the consumer watched the WellnessAd (e.g., via a user interface “Confirm” button) and/or comprehension of the WellnessAd by the consumer (e.g., by recording the consumer's answer to a multiple-choice question and sending it to a web server) as well as additional profile information regarding the consumer.

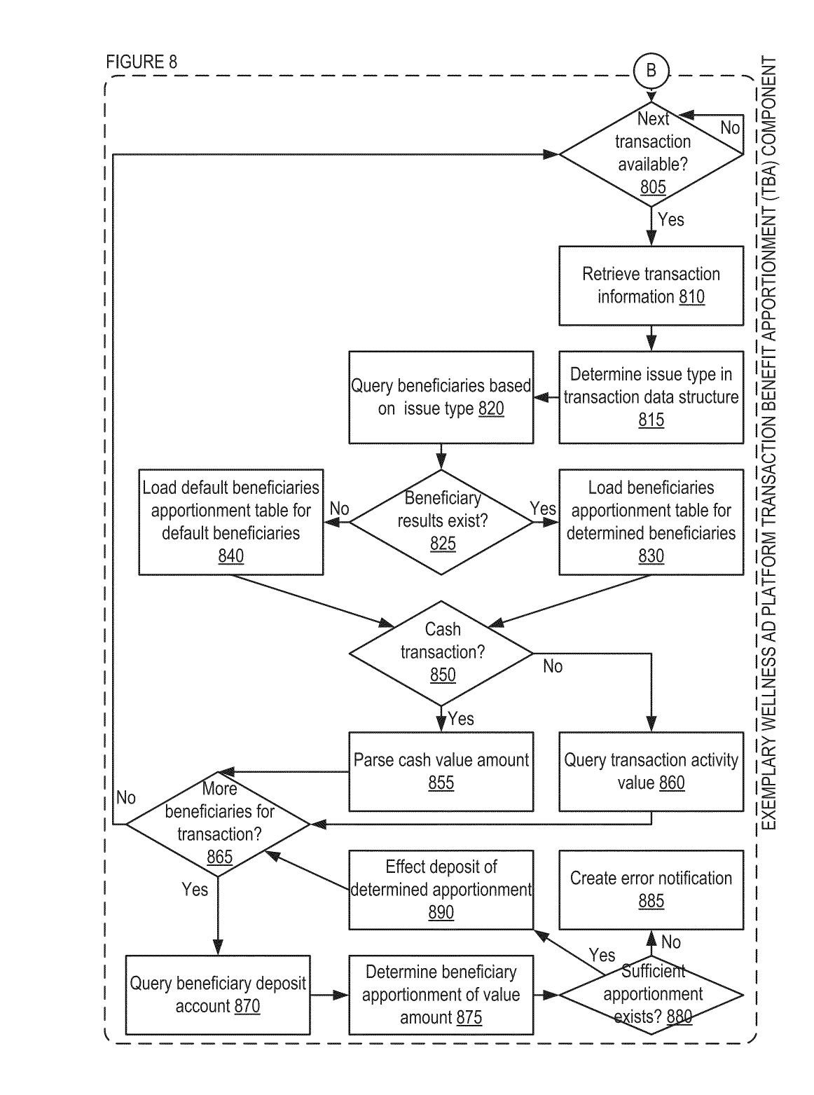

The WellnessAd application may be used by the consumer to select beneficiaries that may receive Credits earned by the consumer by watching the WellnessAd. As illustrated in screen 309, the consumer may select an amount of Credits to be awarded 340. The consumer may also select the location of the intended beneficiary 342 (e.g., based on the consumers current location, consumers preferences, and/or the like). The WellnessAd application may display beneficiaries in the selected location 344 to the consumer (see FIG. 8 for more details regarding an example Beneficiary data structure), and the consumer may select an intended beneficiary 346. For example, the consumer may wish to donate Credits to a local charity, to a local fulfillment partner, to a local WellnessProject, to the local municipality, and/or the like. Since many wellness issues have local ties, consumers may want to ensure that their Credits are going to a wellness project that is located where they live and/or where they are currently located. Accordingly, a stronger tie may exist between the WellnessAd and the consumer as the consumer may view watching the advertisement not only as being informative, but also as helping to contribute a benefit back to the overall wellness of the community that the consumer may direct to a location/WellnessProject as the consumer deems fit. Providing the consumer with updates regarding the Wellness Project's progress (e.g., how much of the project has already been funded, how much funding remains to be obtained, how the WellnessProject has benefitted the consumer, and/or the like) may make the tie even stronger. Furthermore, such stronger emotional ties (e.g., connection with the WellnessProject, location, and/or the like) may further encourage the consumer to increase his/her contribution. In one embodiment, the WELLNESS AD PLATFORM may connect with social-oriented service organizations (e.g., micro-loans), such as kiva.org, to facilitate beneficiary selection. Also, consumers may select friends in their social graph, for example, friends from Facebook, LinkedIn, their instant messenger buddy list, twitter, email contacts, and/or the like. Furthermore, the WellnessAd application may provide educational messages to the consumer 348 (e.g., to help the consumer improve their personal health or the overall wellness of the community).

The WellnessAd application may also be used by the consumer to view Credit statistics (e.g., cumulative total amount of Credits generated by the consumer, Credits generated by the consumer this month, the amount of Credits donated to a WellnessProject, the amount of Credits donated to a charity, and/or the like) and/or compare the amount of Credits generated/donated by the consumer 350 to those of the consumers friends or associates 352 (e.g., compared to other people that used a kiosk, the consumer's friends on social networks, and/or the like), as illustrated in screen 319. For example, providing such statistics may promote friendly competition between friends to see who earns the most Credits, who donates the most Credits, and/or the like, and may motivate consumer behavior generating Credits (e.g., choosing certain products/services because they generate higher Credits than other products/services). Additional game mechanics (e.g., earning badges for achieving certain levels of Credits or supporting certain projects) may also be used to further motivate consumers' behavior in engaging more regularly with the WELLNESS AD PLATFORM.

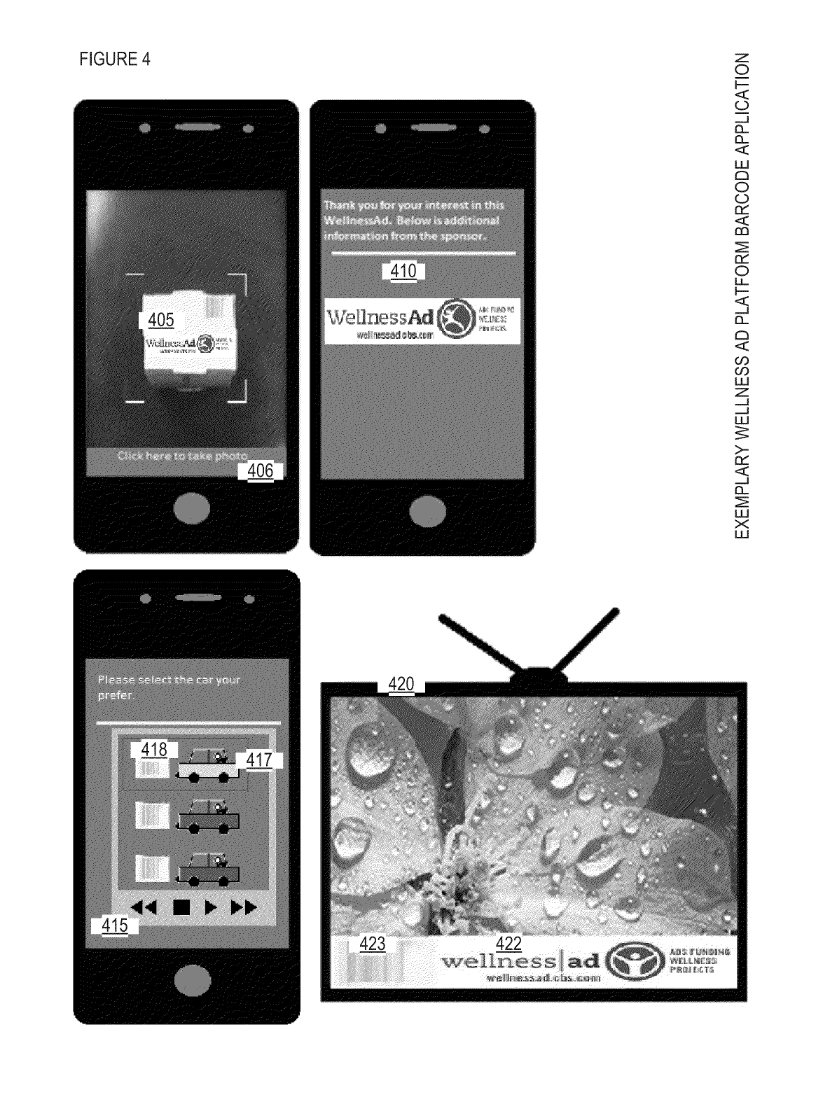

FIG. 4 shows a screen shot diagram illustrating a WellnessAd barcode application in one embodiment of the WELLNESS AD PLATFORM. In one implementation, the WellnessAd barcode application may be a separate application. In another implementation, the WellnessAd barcode application may be a part of the WellnessAd application. In FIG. 4, a barcode-linked WellnessAd 405 may be viewed by the consumer (e.g., a print WellnessAd, a billboard WellnessAd, a TV WellnessAd, a radio WellnessAd, and/or the like). In one implementation, a barcode may be a visual image (e.g., a linear barcode, a 2D barcode, and/or the like). In another implementation, a barcode may be an audio mnemonic (e.g., a jingle, a tune, and/or the like). For example, audio identification technologies, such as Shazam, may be used to identify an audio mnemonic and/or to detect identifying information (e.g., carried in a high frequency audio band inaudible to human ear) carried by an audio mnemonic. The consumer may earn Credits by taking a snapshot of a visual barcode 406 and/or recording the tune of an audio mnemonic using the WellnessAd barcode application. For example, taking the snapshot of the barcode may serve as a confirmation to the advertiser that the barcode-linked WellnessAd was viewed by the consumer and may provide WellnessAd usage statistics to the advertiser regarding who viewed the WellnessAd (e.g., based on the WellnessID of the consumer, the GPS information regarding the consumer's location, and/or the like). This is of particular value in one-way advertising channels normally incapable of confirming ad impressions such as billboards, print advertising, broadcast radio/television, and/or the like. Such one-way advertising channels may participate in the WELLNESS AD PLATFORM by including barcodes, for example, by printing barcodes on billboards and print ads, providing discernible audio prints, placing barcodes in banner overlays on television. For example, a WellnessAd with a barcode displayed on a television is illustrated at 420. The WellnessAd 422 overlays a television program, online video, and/or the like video, and the application user may obtain Credits by taking a picture of the barcode 423 associated with the WellnessAd. Also, such barcodes may even be placed in two-way advertising channels for enhanced experiences; for example, placing a barcode in web banner ad might allow the mobile WellnessAd application user to snap the ad and obtain credit for consuming a WellnessAd associated with his/her profile while snapping the WellnessAd on a friend's computer. In another example, an online video WellnessAd about cars may be displayed (e.g., on a computer monitor) and a picture of the video (e.g., as displayed on the computer monitor) may be taken using a mobile device as illustrated at 415. The application user may obtain Credits by selecting a car that the user liked 417 after seeing the WellnessAd video using the barcode 418. In response to taking the snapshot of the barcode, the WellnessAd barcode application may provide additional information 410 from the advertiser to the consumer. In one embodiment, the WellnessAd barcode application may inform the consumer regarding the amount of Credits earned by the consumer. In one implementation, the Credits earned by the consumer may be used to help with a wellness issue, may be gifted to a charity or a friend, and/or the like.

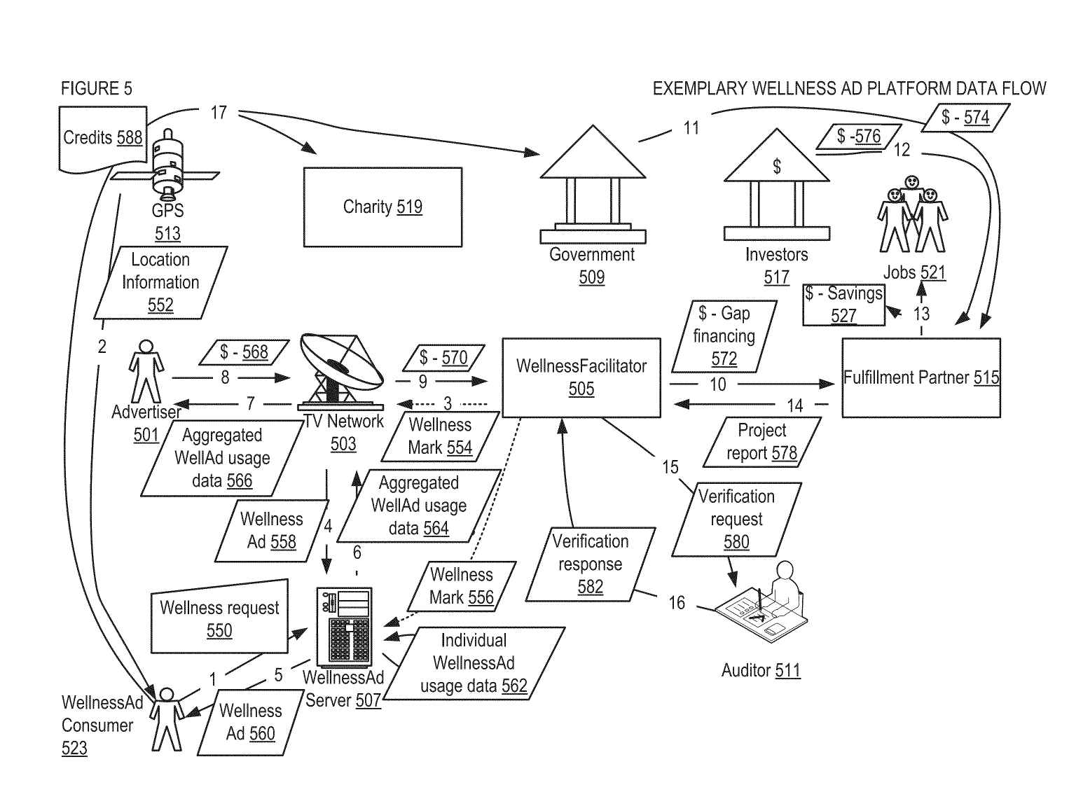

FIG. 5 shows a data flow diagram in one embodiment of the WELLNESS AD PLATFORM. This data flow begins with wellness request 550 (see examples below) from a WellnessAd consumer 523 that is received by a WellnessAd Server 507. For example, the WellnessAd consumer may wish to help with a wellness issue of interest to the consumer. In one embodiment, the wellness request may be received from a kiosk (e.g., a WellnessAd kiosk). For example, the wellness request may be in XML format substantially in the following form:

<XML>

<WellnessRequest>

<UserID>ID123</UserID>
<HelpType>WellnessAd</HelpType>
<HelpAmount>$1</HelpAmount>
<KioskID>ID321</KioskID>
<KioskLocation>New York City</KioskLocation>

</WellnessRequest>

</XML>

The wellness request may include a UserID identifying the consumer. In one implementation, the UserID may correspond to the ConsumerID of the consumer in the Consumer data structure (see FIG. 7 for more details regarding the Consumer data structure). In another implementation, the UserID may correspond to the LoginName of the consumer in the Consumer data structure.

See FIG. 2 for additional details regarding a WELLNESS AD PLATFORM kiosk. In another embodiment, the wellness request may be received from a WELLNESS AD PLATFORM application (e.g., a desktop, a mobile, a web-based application, and/or the like). For example, the wellness request may be in XML format substantially in the following form:

<XML>

<WellnessRequest>

<UserID>ID456</UserID>
<IssueType>Cardiovascular Disease</IssueType>
<IssueSubType>Early Detection</IssueSubType>
<HelpType>Cash</HelpType>
<HelpAmount>$2</HelpAmount>
<ApplicationVersion>v1.1</ApplicationVersion>
<DeviceLocation>San Francisco</DeviceLocation>

</WellnessRequest>

</XML>

See FIG. 3 for additional details regarding a WELLNESS AD PLATFORM application. In yet another embodiment, the wellness request may be received as a result of the consumer interacting with a barcode-linked WellnessAd (e.g., a print WellnessAd, a billboard WellnessAd, a TV WellnessAd, a radio WellnessAd, and/or the like) via a WELLNESS AD PLATFORM barcode application. See FIG. 4 for additional details regarding a WELLNESS AD PLATFORM barcode application. The WELLNESS AD PLATFORM barcode application may be a part of the WELLNESS AD PLATFORM application. For example, the wellness request may be in XML format substantially in the following form:

<XML>

<WelnessRequest>

<UserID>ID789</UserID>
<HelpType>Barcode</HelpType>
<HelpAmount>$1</HelpAmount>
<Location>New York City</Location>
<WellnessAdID>ID987</WellnessAdID>
<BarcodeImage>image1</BarcodeImage>
<BarcodeID>BarID123</BarcodeID>

</WellnessRequest>

</XML>

The wellness request may include location information (e.g., regarding the consumer's location). A GPS device 513 may provide location information 552 associated with a consumer's mobile device (e.g., a cell phone).

The WellnessFacilitator 505 may certify an advertisement with a WellnessMark 554, 556 to indicate that the advertisement is a WellnessAd. For example, the certification may be done using public key cryptography to verify that the advertisement sent for certification came from an authorized advertiser. For example, a digitally signed advertisement may be sent to the WellnessFacilitator encrypted using an advertisers private key. The WellnessFacilitator may determine the advertiser using the identifying information in the digital signature, verify that the advertiser is an authorized advertiser by checking the advertisers ID against a list of IDs of authorized advertisers, retrieve the advertisers public key (e.g., from a database that maps advertiser IDs to public keys), and decrypt the digitally signed advertisement. If the decryption is successful, the WellnessFacilitator may certify the advertisement as a WellnessAd. Also, the WellnessFacilitator may certify WellnessAds and place them on the WellnessAd Server 507. In another implementation, the WellnessFacilitator may certify WellnessAds available from the TV Network 503, and the TV Network may place the WellnessAds 558 on the WellnessAd Server. A WellnessAd 560 may be played back to the WellnessAd consumer 523 in response to receiving a wellness request. For example, a WellnessAd may take the form of an image (e.g., JPEG, GIF, PNG, and/or the like), video (e.g., MPEG2, H264, and/or the like), audio (MP3, AAC, WMA, and/or the like), and/or the like. WellnessAd identifying information (e.g., see FIG. 7 for more details regarding the Advertisement data structure) may be encoded in a file containing the WellnessAd (e.g., the file may be tagged with identifying information using the ID3 tags using MP3 audio format).

Individual WellnessAd usage data regarding individual transactions may be recorded by the WellnessAd server. Such captured usage data may be aggregated for analytics and feedback into the WELLNESS AD PLATFORM to improve future WellnessAds and WELLNESS AD PLATFORM performance. Such individual WellnessAd usage data may include information regarding which WellnessAd a consumer watched, the length of the WellnessAd, whether the consumer confirmed viewing the WellnessAd, whether the consumer understood the WellnessAd, whether the consumer liked the WellnessAd, demographic information regarding the consumer and/or the like. For example, the individual WellnessAd usage data may be in XML format substantially in the following form:

<XML>

<IndividualAdUsageData>

<WellnessAdID>ID223</WellnessAdID>
<WellnessAdType>Web</WellnessAdType>
<ViewTime>30 seconds</ViewTime>
<Confirmation>Yes</Confirmation>
<Comprehension>No</Comprehension>
<ComprehensionQuestionID>ID1</ComprehensionQuestionID>
<ComprehensionAnswer>C. Yellow</ComprehensionAnswer>
<LikedWellnessAd>Yes</LikedWellnessAd>

</IndividualAdUsageData>

</XML>

Aggregate WellnessAd usage data 564, 566 regarding WellnessAds may be provided (e.g., by the WellnessAd Server 507) to the TV Network 503 and/or to the advertiser 501. For example, the aggregate WellnessAd usage data may include information such as which WellnessAds were viewed, whether the consumers confirmed that the consumers saw a WellnessAd, whether the consumers understood the content of a WellnessAd, whether the consumers liked a WellnessAd, the number of times a WellnessAd was shown to the consumers, demographic information regarding viewers of a WellnessAd, location information regarding viewers of a WellnessAd and/or the like. Such aggregate WellnessAd usage data may be in XML format substantially in the following form:

<XML>

<AggregateAdUsageData>

<WellnessAdID>ID234</WellnessAdID>
<WellnessAdType>Web</WellnessAdType>
<Usage>

<Location>New York City</Location>
<ViewerDemographics>

<Age_19_to_24>15%</Age_19_to_24>
...
<Gender_Male>45%</Gender_Male>
...

</ViewerDemographics>
<AverageViewTime>30 seconds</AverageViewTime>
<Confirmation>40%</Confirmation>
<Comprehension>25%</Comprehension>

</Usage>
<Questions>

<Question>

<QuestionID>ID1</QuestionID>
<Text>Available color for the drink?</Text>
<Answer>

<Text>A. Blue</Text>
<Correct>Yes</Correct>
<Answered>50%</Answered>

</Answer>
<Answer>

<Text>B. Red</Text>
<Correct>No</Correct>
<Answered>30%</Answered>

</Answer>
<Answer>

<Text>C. Yellow</Text>
<Correct>No</Correct>
<Answered>20%</Answered>

</Answer>

</Question>

</Questions>
...

</AggregateAdUsageData>

</XML>

Individual and/or aggregate WellnessAd usage data may be used (e.g., by the advertiser 501), to determine the payment amount 568, 570 that the advertiser should pay to the TV Network 503 and/or to the WellnessFacilitator 505 as a result of the WellnessAd consumer 523 watching the advertiser's WellnessAd. See FIG. 7 for additional details regarding how the payment amount associated with a WellnessAd may be determined.

The WellnessFacilitator 505 may provide financing 572 (e.g., seed, supplemental, and/or gap funding) to a WellnessProject fulfillment partner 515 (e.g., a mobile clinic organizer) for a WellnessProject (e.g., providing free cancer screenings in a mobile clinic) using funds received from advertisers. With funding available, the fulfillment partner may obtain additional funding 574, 576 from other sources such as a government 509 (e.g., local municipality, city government, county government, state government, federal government, and/or the like), investors 517 (e.g., banks, venture capitalists, and/or the like), and/or the like and may proceed with the WellnessProject. Positive impact of the WellnessProject may include healthier communities, local jobs 521 (e.g., to build and/or operate the WellnessProject), additional tax revenue, lower health costs, savings 527, and/or the like.

The fulfillment partner may provide the WellnessFacilitator with a project report 578 detailing the impact (e.g., stored in the Impact database table 1319h) of the WellnessProject (e.g., a mobile health clinic), standards and/or methodologies used to determine the impact, and/or the like. In many embodiments, it will be preferred to measure project outputs rather than outcomes. The project report may be used by the WellnessFacilitator to determine whether the fulfillment partner satisfied its obligations (e.g., future funding may be discontinued if the fulfillment partner failed to deliver acceptable results). In one implementation, the project report may be in XML format substantially in the following form:

<XML>

<ProjectReport>

<EntityID>ID345</EntityID>
<EntityType>Clinic</EntityType>
<EntitySubType>Disease Testing</EntitySubType>
<ResultsProduced>100 diagnoses</ResultsProduced>
<IssueType>Diabetes</IssueType>
<Location>San Francisco</Location>

</ProjectReport>

</XML>

The WellnessFacilitator may review the project report and confirm data (e.g., costs, savings, jobs generated, results achieved), calculations, and/or the like. The WellnessFacilitator may also send a verification request 580 to an auditor 511 to perform additional verification. In one implementation, the verification request may be in XML format substantially in the following form:

```
<XML>
      <VerificationRequest>
            <EntityID>ID345</EntityID>
            <IssueType>Obesity</IssueType>
            <ResultsProduced>100 people with lower BMI
            </ResultsProduced>
            <BMI_Calculator>NIH Body Mass Index Calculator
            </BMI_Calculator>
            <CostPerPerson>$100</CostPerPerson>
            <JobsGenerated>10</JobsGenerated>
            <Location>San Francisco</Location>
      </VerificationRequest>
</XML>
```

The auditor may provide a verification response 582 indicating whether the data, calculations, and/or the like have been verified, whether the standards and/or methodologies used in various calculations are acceptable, and/or the like. In one implementation, the verification response may be in XML format substantially in the following form:

```
<XML>
      <VerificationResponse>
            <EntityID>ID345</EntityID>
            <ResultsProduced>Verified</ResultsProduced>
            <BMI_Calculator>Acceptable</BMI_Calculator>
            <CostPerPerson>Verified</CostPerPerson>
            <JobsGenerated>Need additional information
            </JobsGenerated>
      </VerificationResponse>
</XML>
```

In some embodiments, the auditor may interact with the fulfillment partner during the verification. For example, the auditor may visit the WellnessProject site to confirm results. In another example, the auditor may provide the fulfillment partner with verification results and/or request that the fulfillment partner provide additional explanation regarding selected information.

The WELLNESS AD PLATFORM may facilitate user selection of beneficiaries of the credits 588 awarded to the user (e.g., for watching WellnessAds). For example, the consumer may elect to keep the credits, give the credits to a charity and/or nonprofit organization 519, give the credits to a local municipality 509, give the credits to a fulfillment partner, give the credits to a WellnessProject, give the credits to a friend, and/or the like.

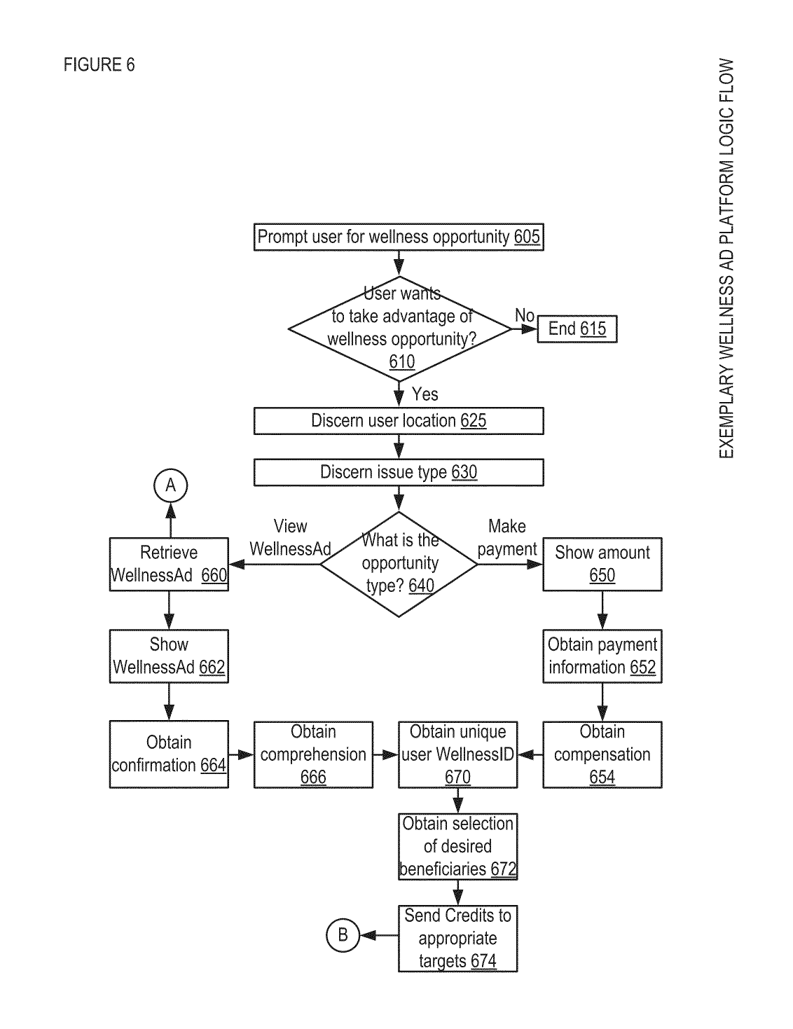

FIG. 6 shows a logic flow diagram in one embodiment of the WELLNESS AD PLATFORM. For example, this logic may be used to implement the WellnessAd Kiosk (see FIG. 2), WellnessAd application (see FIG. 3), and/or the like. In FIG. 6, the consumer may be prompted for a wellness opportunity at 605. For example, a consumer may care about a wellness issue, and may wish to help with the wellness issue. In one embodiment, the consumer may be prompted by a WELLNESS AD PLATFORM kiosk (e.g., at the doctor's office, at the beginning or end of a cab, train or airplane ride) via the kiosk's user interface. See FIG. 2 for additional details regarding a WELLNESS AD PLATFORM kiosk. In another embodiment, the prompting may take the form of the consumer activating a WELLNESS AD PLATFORM application (e.g., a desktop, a mobile, a web-based application and/or the like). See FIG. 3 for additional details regarding a WELLNESS AD PLATFORM application. In yet another embodiment, the prompting may take the form of the consumer interacting with a barcode-linked WellnessAd (e.g., a print WellnessAd, a billboard WellnessAd, a TV WellnessAd, a radio WellnessAd, and/or the like) via a WELLNESS AD PLATFORM barcode application. In one implementation, the WELLNESS AD PLATFORM barcode application may be a part of the WELLNESS AD PLATFORM application. See FIG. 4 for additional details regarding a WELLNESS AD PLATFORM barcode application.

A determination may be made at 610 whether the consumer wants to help with a wellness issue. If the consumer does not wish to help with a wellness issue, the WELLNESS AD PLATFORM logic flow ends at 615. Otherwise, the WELLNESS AD PLATFORM discerns the consumer's location at 625. The consumer's location may be discerned based on coordinates provided by a GPS toolkit (e.g., of a mobile device equipped with a GPS). In one implementation, Google's Android operation system's (OS's) Location Manager may be used substantially as follows:

```
LocationManager locationManager =
(LocationManager)
this.getSystemService(Context.LOCATION_SERVICE);
LocationListener locationListener = new LocationListener( )
{
  public void onLocationChanged(Location geoLocation) {
    provideNewLocation(geoLocation);
  }
};
locationManager.requestLocationUpdates
(LocationManager.NETWORK_PROVIDER, 0, 0, locationListener);
locationManager.requestLocationUpdates
(LocationManager.GPS_PROVIDER, 0, 0, locationListener);
```

The returned geolocation may be used for location based queries thereafter. In another implementation, toolkits for Apple's iOS, Palm's WebOS, and/or the like may be used. In another embodiment, the consumer's location may be discerned based on information supplied by the consumer. In yet another embodiment, the consumer's location may be discerned based on preset information (e.g., location information of a stationary kiosk in a store).

The wellness issue of interest to the consumer may be discerned at 630. For example, the wellness issue of interest may be cardiovascular disease. In one embodiment, the wellness issue type may be preset (e.g., a kiosk in a Cardiologist's office may be preset with cardiovascular disease wellness issue type). In another embodiment, the consumer may select the wellness issue type (e.g., via a user interface—for example, see FIG. 3). The monetary value of the consumer's help may also be determined. In one embodiment, the monetary value may be determined by the identity, type, number, and/or the like of WellnessAds viewed by the consumer. In another embodiment, the monetary value may be specified by the consumer (e.g., a $5 payment). In yet another embodiment, the WELLNESS AD PLATFORM may specify the monetary value (e.g., ask the consumer to donate a predetermined amount and/or to watch a predetermined number of WellnessAds) requested. For example, the consumer may choose the locality to benefit from the consumer's help, which may affect the monetary value requested by the WELLNESS AD PLATFORM.

A determination may be made at 640 regarding how the consumer wants to help. In one embodiment, the consumer may choose to make a payment (e.g., using a credit card, a bank account, and/or the like) to help with the wellness issue of interest. The consumer may enter their payment type selection and information associated with the consumers preferred payment method via a number of input mechanisms including a touch screen keyboard into user interface elements displayed on the screen (e.g., text fields of a web form), swiping a credit card past a magnetic/RFID reader, passing an NFC capable smartphone, and/or the like. The consumer may be informed regarding the payment amount (e.g., shown the charge on a screen) at 650. Payment information may be obtained from the consumer at 652 (e.g., the consumer's credit card number, bank account number, and/or the like), and compensation may be obtained at 654. In another embodiment, the consumer may choose to view WellnessAds to help with the wellness issue of interest. WellnessAds (e.g., one or multiple) with viewer impression cost sufficient to cover the payment amount for the wellness issue of interest may be retrieved at 660. See FIG. 7 for additional details regarding retrieving suitable WellnessAds. The retrieved WellnessAd may be shown to the consumer at 662. In one embodiment, the advertiser may pay a higher rate for watching the WellnessAd if the advertiser receives confirmation that the consumer watched the WellnessAd, and/or comprehended the WellnessAd. For example, a confirmation may be obtained from the consumer 664 that the consumer watched the WellnessAd (e.g., the consumer may click a button on a screen to confirm that the consumer watched the entire WellnessAd). In another example, comprehension of the WellnessAd by the consumer may be obtained at 666 (e.g., an advertiser may show a WellnessAd regarding a sports drink and may present a consumer with a multiple-choice question regarding the flavors in which the sports drink is available). The WELLNESS AD PLATFORM may display information (e.g., pictures, video, and/or the like) to the consumer regarding the WellnessProject that was helped by watching the WellnessAd.

If the consumer has an account with the WELLNESS AD PLATFORM, the WELLNESS AD PLATFORM may obtain the consumer's unique WellnessID at 670. For example, the consumer's account may indicate consumer preferences regarding which types of WellnessAds the consumer prefers to watch, may include a list of preferred beneficiaries to receive Credits, and/or the like. In some implementations, the consumer's account may be used to reward the consumer for participation and involvement with the WELLNESS AD PLATFORM. For example, the consumer's name may be published in a listing of top contributors, the consumer may be awarded badges, the consumer may earn Credits, and/or the like when the consumer or members of the consumer's social network watch, confirm, comprehend, and/or somehow consume WellnessAds. Furthermore (consistent with privacy policies and consumer permissions), data regarding the consumer's participation and involvement with the WELLNESS AD PLATFORM may be provided to advertisers. The consumers profile may be retrieved using a SQL query substantially in the following form:

SELECT Preferences_AdContentType, Preferences_Advertisers,
Preferences_Beneficiaries
FROM Consumer
WHERE ConsumerID = “CID1”

The selection of desired beneficiaries may be received from the consumer at 672. In one implementation, the consumer may select the desired beneficiaries from a list of preferred beneficiaries (e.g., see FIG. 8 for more details regarding Beneficiary data structure). In another implementation, the consumer may select beneficiaries from a list presented by the WELLNESS AD PLATFORM based on the issue of interest. In yet another implementation, the consumer may choose to have the WELLNESS AD PLATFORM select the beneficiaries (e.g., based on a list containing default beneficiaries). The Credits may be sent to appropriate targets at 674. For example, the Credits accounts of beneficiaries may be credited the appropriate amount. See FIG. 8 for additional details regarding apportioning benefits.

FIG. 7 shows a logic flow diagram illustrating an advertisement retrieving (AR) component 1344 in one embodiment of the WELLNESS AD PLATFORM. For example, the AR component may be used to retrieve WellnessAds with viewer impression cost sufficient to cover the payment amount for the wellness issue of interest. The Advertisement data structure may be used to help determine which WellnessAds to display to the consumer, to help determine which WellnessProjects should receive funds from displaying a WellnessAd and how to allocate the funds, and/or the like, and may be in XML format substantially in the following form:

```
<XML>
<Advertisement>
  <AdvertisementID>AdID1</AdvertisementID>
  <AdvertisementType>TV</AdvertisementType>
  <ContentType>Sports Products</ContentType>
  <MediaLink>Link1</MediaLink>
  <IssuesList>IID1, IID2</IssuesList>
  <ProjectsSupported>
        <Locations>California, New York</Locations>
        <Tags>tag2,tag3</Tags>
        <FundingAllocation>
              <Recipient>
                    <RecipientID>RID5</RecipientID>
                    <Allocation>30%</Allocation>
              </Recipient>
              <Recipient>
                    <RecipientID>RID6</RecipientID>
                    <Allocation>30%</Allocation>
              </Recipient>
              <Recipient>
                    <RecipientID>RID7</RecipientID>
                    <Allocation>40%</Allocation>
              </Recipient>
        </FundingAllocation>
  </ProjectsSupported>
  <Contribution>
        <LocationID>LID1</LocationID>
        <Demographics><TargetAge>25-49</TargetAge></Demographics>
        <AdvertisementSubType>DEFAULT</AdvertisementSubType>
        <AdvertiserContributionAmount>$2</AdvertiserContributionAmount>
        <ContentTypePremiumAmount>+$0.40</ContentTypePremiumAmount>
  </Contribution>
  <Contribution>
        ...
        <AdvertisementSubType>TV_BARCODE</AdvertisementSubType>
        <AdvertiserContributionAmount>$3</AdvertiserContributionAmount>
  </Contribution>
</Advertisement>
<Advertisement>
  <AdvertisementID>AdID2</AdvertisementID>
  <AdvertisementType>Web</AdvertisementType>
  <ContentType>Food</ContentType>
  <MediaLink>Link1</MediaLink>
  <DeviceCapabilities>
        <ScreenOrientation>Horizontal</ScreenOrientation>
        <ScreenSize>7+ inches</ScreenSize>
        <ScreenResolution>1024×768</ScreenResolution>
        <AudioCapability>Yes</AudioCapability>
        <PhysicalKeyboard>Yes</PhysicalKeyboard>
        <CreditCardReader>No</CreditCardReader>
  </DeviceCapabilities>
  <Contribution>
        ...
        <AdvertisementSubType>WEB_CLICK</AdvertisementSubType>
        <AdvertiserContributionAmount>$2</AdvertiserContributionAmount>
  </Contribution>
  <Contribution>
        ...
        <AdvertisementSubType>WEB_COMPREHEND</AdvertisementSubType>
        <AdvertiserContributionAmount>$3</AdvertiserContributionAmount>
  </Contribution>
  <Contribution>
        ...
        <AdvertisementSubType>WEB_SELECT</AdvertisementSubType>
        <AdvertiserContributionAmount>$4</AdvertiserContributionAmount>
  </Contribution>
  <Contribution>
        ...
  <AdvertisementSubType>WEB_SELECT_COMPREHEND</AdvertisementSubType>
        <AdvertiserContributionAmount>$5</AdvertiserContributionAmount>
  </Contribution>
</Advertisement>
<Advertisement>
  ...
  <AdvertisementType>Print</AdvertisementType>
        ...
        <AdvertisementSubType>PRINT_BARCODE</AdvertisementSubType>
        <AdvertiserContributionAmount>$3</AdvertiserContributionAmount>
</Advertisement>
</XML>
```

Data in the Advertisement data structure may be obtained from an advertiser and may be stored in the Advertisement database table 1319c. The Advertisement data structure may include information such as a WellnessAd's AdvertisementID that uniquely identifies the WellnessAd, the WellnessAd's AdvertisementType (e.g., TV, Web, Print, Radio, and/or the like) that may indicate a media outlet through which the WellnessAd may be exhibited, advertisement files (e.g., images, videos, audios, and/or the like of the WellnessAd), and/or the like. The Advertisement data structure may have a ContentType that may describe the type of product being advertised (e.g., sports products, food, and/or the like). In one implementation, the ContentType of a WellnessAd may be compared with consumer preferences in a Consumer data structure to provide the consumer with WellnessAd content in which the consumer is interested. The Advertisement data structure may include a MediaLink to the WellnessAd content (e.g., the location of the video file that contains the WellnessAd). For example, if the WellnessAd is selected for playback to the consumer, the WellnessAd is played back from the location indicated by the MediaLink (e.g., the location of the WellnessAd file on a local storage device such as “C:\WellnessAds\WellnessAd1.avi”). Alternatively, the actual data for the media object may be embedded in the MediaLink field. The Advertisement data structure may include information such as locations of interest to the advertiser (e.g., the advertiser may wish to support only WellnessProjects that affect specified locations), tags associated with the project that are of interest to the advertiser (e.g., the advertiser may wish to support only WellnessProjects that have to do with mobile health clinics), funding allocation schedule (e.g., specifying a list of projects and a proposed allocation of funds for each project) for the funds generated through displaying the WellnessAd. This information may be used to allocate funds generated through displaying a WellnessAd among WellnessProjects. The Advertisement data structure may include information such as contribution amounts (e.g., stored in the AdvertiserContributionAmount field of the Advertisement data structure) that an advertiser may be willing to pay for having the consumer watch a WellnessAd and these contribution amounts may vary based on the location of the consumer, demographic information associated with the consumer, confirmation that the consumer viewed the WellnessAd, comprehension of the WellnessAd by the consumer, explicit selection of the WellnessAd by the consumer, content type of the WellnessAd, and/or the like, and/or any combination of the above. The Advertisement data structure may have information regarding the AdvertiserContributionAmount associated with a LocationID and content premiums associated with contribution amounts. For example, the advertiser may be willing to pay $2 to display a WellnessAd at location LID1, and $3 to display the WellnessAd at location LID2. The Advertisement data structure may have information regarding the target demographics for a WellnessAd. In one embodiment, the Advertisement data structure may have an AdvertisementSubType that may indicate the AdvertiserContributionAmount the advertiser may be willing to pay for various WellnessAd formats. For example, the advertiser may be willing to pay $2 to display a WellnessAd on TV (e.g., DEFAULT AdvertisementSubType). In another example, the advertiser may be willing to pay $3 to display a WellnessAd on TV if the consumer takes a picture of the WellnessAd barcode (e.g., using the WellnessAd barcode application). In yet another example, the advertiser may be willing to pay $2 if the consumer watches a web based WellnessAd and confirms watching the WellnessAd (e.g., by clicking on a button in a kiosk). In yet another example, the advertiser may be willing to pay $3 if the consumer watches a web based WellnessAd and comprehends the WellnessAd (e.g., by correctly answering a question using a WellnessAd application). In yet another example, the advertiser may be willing to pay $4 if the consumer explicitly selects a web based WellnessAd (e.g., from one of the available WellnessAds presented to the consumer). In yet another example, the advertiser may be willing to pay $5 if the consumer explicitly selects a web based WellnessAd and comprehends the WellnessAd. The Advertisement data structure may be adjusted to improve the effectiveness of WellnessAds based on consumer feedback. For example, information regarding consumers' interactions with a WellnessAd may be recorded, aggregated and analyzed to refine how a WellnessAd is displayed (e.g., location where the WellnessAd is most effective, button placement of WellnessAd components, and/or the like). Furthermore, WellnessAds may be adjusted by aggregating user interactions with different usage models (e.g., within a cab, in an elevator, in front of a computer at home or at work, in a doctor's office, and/or the like) and customizing parameters (e.g., screen resolution, length, message, and/or the like) of the WellnessAds to facilitate effectiveness of the WellnessAds as well as to maximize the follow-on Credits donations.

The Consumer data structure may store information regarding a WellnessAd consumer, regarding the consumers preferences, regarding other accounts associated with the consumer, and/or the like, and may be in XML format substantially in the following form:

```
<XML>
<Consumer>
  <ConsumerID>CID1</ConsumerID>
  <LoginName>User1</LoginName>
  <FullName>John Doe</FullName>
  <Address>123 Main St, New City, State 11111</Address>
  <Preferences>
        <AdContentType>Sports Products, Food</AdContentType>
        <Advertisers>AdvID1, AdvID3</Advertisers>
        <Beneficiaries>BID1, BID2</Beneficiaries>
  </Preferences>
  <Demographics>
        <Age>40</Age>
        <Gender>Male</Gender>
  </Demographics>
  <AdditionalProfiles>
        <Profile>
              <LinksTo>games.cbs.com</LinksTo>
              <UserID>UID1</UserID>
              <Password>Password1</Password>
        </Profile>
        <Profile>
              <LinksTo>facebook.com</LinksTo>
              <UserID>UID2</UserID>
              <Password>Password2</Password>
        </Profile>
  </AdditionalProfiles>
</Consumer>
<Consumer>
  <ConsumerID>CID2</ConsumerID>
  ...
  <Preferences>
        <AdContentType>Food, Cleaning Products</AdContentType>
        <Advertisers>AdvID2, AdvID3</Advertisers>
        <Beneficiaries>BID2, BID3</Beneficiaries>
  </Preferences>
  <Demographics>...</Demographics>
  <AdditionalProfiles>
        ...
  </AdditionalProfiles>
</Consumer>
</XML>
```

The Consumer data structure may be stored in the Consumer database table 1319d. The Consumer data structure may be used to help determine which WellnessAds to display to the consumer. A consumer may have a ConsumerID that uniquely identifies the consumer. The Consumer data structure may have a LoginName that the consumer may use as the consumers WellnessID (e.g., to login to the consumers WELLNESS AD PLATFORM account). The Consumer data structure may have information regarding the consumer such as the consumers full name, the consumers address, demographic information regarding the consumer (e.g., age, gender, place of employment, job title, location, and/or the like), and/or the like. Information regarding the consumer may be compared with target demographic information of a WellnessAd (e.g., stored in the Advertisement data structure) and/or with target demographic information of a WellnessAd Campaign (e.g., stored in the Advertiser data structure) to help determine which WellnessAds to present to the consumer. The Consumer data structure may have information regarding the consumers AdContentType preferences. For example, consumer CID1 may prefer to watch WellnessAds regarding Sports Products and Food. In another example, consumer CID2 may prefer to watch WellnessAds regarding Food and Cleaning Products. The consumers AdContentType preferences may be compared with the ContentType associated with a WellnessAd to help determine suitable WellnessAds to present to the consumer. The Consumer data structure may have information regarding the consumers advertisers preferences. For example, consumer CID1 may prefer to view WellnessAds from advertisers AdvID1 and AdvID3. In another example, consumer CID2 may prefer to view WellnessAds from advertisers AdvID2 and AdvID3. The consumers advertisers preferences may be compared with the AdvertiserID of an advertiser to help determine suitable WellnessAds to present to the consumer. Furthermore, the consumer may be associated with one or more consumer types (e.g., a student, a software developer, a mother, a father, and/or the like) and the profile information associated with consumer types may help provide more effective linking between WellnessAds and the consumer, which may further increase the tie between the consumer and the WellnessAd. For example, the consumer may be presented with WellnessAds that support a WellnessProject that the consumer cares about. The Consumer data structure may have information regarding the consumers beneficiary preferences (see FIG. 8 for more details regarding the Beneficiary data structure). For example, consumer CID1 may prefer that the Credits earned by the consumer are given to beneficiaries BID1 and BID2. In another example, consumer CID2 may prefer that the Credits earned by the consumer are given to beneficiaries BID2 and BID3. The consumers preferred beneficiaries may be presented (e.g., to select from a list) to the consumer (e.g., in a kiosk, in a WellnessAd application, and/or the like) to facilitate selection of Credit recipients. The consumer may link additional profiles to the consumers WELLNESS AD PLATFORM account. For example, the consumer may link a gaming account, a Facebook account, and/or the like. Information regarding the consumer associated with the linked accounts may be used to help determine which WellnessAds to present to the consumer. Information regarding the consumer may be shared across the linked accounts (e.g., periodic messages may be posted on Facebook on the consumers wall indicating how many Credits the consumer earned this month).

The Advertiser data structure may be used to facilitate payment for displaying WellnessAds by advertisers, to help determine which WellnessAds to display to the consumer, to help determine which WellnessProjects should receive funding from an advertiser, and/or the like, and may be in XML format substantially in the following form:

```
<XML>
<Advertiser>
  <AdvertiserID>AdvID1</AdvertiserID>
  <AdvertiserName>AdvName1</AdvertiserName>
  <Address>678 Main St, New York, NY 11112</Address>
  <Industry>Food</Industry>
  <Description>Description about advertiser</Description>
  <BankAccountNumber>13579</BankAccountNumber>
  <Campaigns>
        <Campaign>
              <CampaignID>CID1</CampaignID>
              <CampaignName>CampaignName1</CampaignName>
              <AdvertisementsList>AdID1, AdID2
              </AdvertisementsList>
              <Preferences>
                    <TargetAge>25-49</TargetAge>
                    <TargetGender>Female</TargetGender>
              </Preferences>
        </Campaign>
        <Campaign>
              <CampaignID>CID2</CampaignID>
              <CampaignName>CampaignName2</CampaignName>
              <AdvertisementsList>AdID3, AdID4
              </AdvertisementsList>
              <Preferences>
                    <TargetAge>19-24</TargetAge>
                    <TargetGender>Male</TargetGender>
              </Preferences>
        </Campaign>
  </Campaigns>
  <ProjectsSupported>
        <Locations>California, New York</Locations>
        <Tags>tag1,tag2</Tags>
        <Costs>
              <Gross>$3,000,000</Gross>
              <Marginal>$250,000</Marginal>
        </Costs>
        <Benefits>
              <FirstYearToGenerationValue>10
              </FirstYearToGenerationValue>
              <LifetimeToGenerationValue>10
              </LifetimeToGenerationValue>
        </Benefits>
  </ProjectsSupported>
</Advertiser>
<Advertiser>
  <AdvertiserID>AdvID2</AdvertiserID>
  <AdvertiserName>AdvName2</AdvertiserName>
  ...
  <BankAccountNumber>24680</BankAccountNumber>
  <Campaigns>
        <Campaign>
              <CampaignID>CID4</CampaignID>
              <CampaignName>CampaignName4</CampaignName>
              <AdvertisementsList>AdID5, AdID6
              </AdvertisementsList>
              <Preferences>...</Preferences>
        </Campaign>
        ...
  </Campaigns>
  ...
</Advertiser>
</XML>
```

Data in the Advertiser data structure may be obtained from an advertiser and may be stored in the Advertiser database table 1319e. The Advertiser data structure may have information such as an AdvertiserID that uniquely identifies the advertiser. The Advertiser data structure may have a BankAccountNumber (e.g., a bank account, a credit card account, and/or the like) associated with the advertiser. The BankAccountNumber may be used to facilitate payment from the advertiser to the TV Network, the WellnessFacilitator, and/or the like for displaying WellnessAds (e.g., to bill the advertiser). The Advertiser data structure may have information such as advertiser name, advertiser address, advertisers industry (e.g., based on SIC codes), description regarding the advertiser, and/or the like. This information may be used to match advertisers with WellnessProjects, to display information regarding the advertiser to WellnessAd consumers, and/or the like. The Advertiser data structure may have information such as locations of interest to the advertiser (e.g., the advertiser may wish to support only WellnessProjects that affect specified locations), tags associated with the project that are of interest to the advertiser (e.g., the advertiser may wish to support only WellnessProjects that have to do with disease testing or obesity prevention), costs (e.g., specifying limits associated with WellnessProject costs), benefits (e.g., specifying benefits desired from an WellnessProject), and/or the like. This information may be used to match advertisers with WellnessProjects, to display information regarding the advertiser to WellnessAd consumers, and/or the like. The Advertiser data structure may have information regarding the advertisers advertising Campaigns. Different advertising Campaigns may include different advertisements and/or may be targeted to different consumer demographics. For example, advertising Campaign CID1 may include advertisements AdID1 and AdID2, and may be targeted to female viewers ages 25 to 49. In another example, advertising Campaign CID2 may include advertisements AdID3 and AdID4, and may be targeted to male viewers ages 19 to 24. The advertisers target demographic information may be compared with information regarding the consumer (e.g., information in the Consumer data structure) to help determine which WellnessAds to present to the consumer.

In FIG. 7, a determination may be made at 710 regarding WellnessAds that are available for the consumers location. The consumers location (e.g., obtained using a configuration file of a kiosk) may be compared to the LocationIDs of the Advertisement data structures associated with WellnessAds to make this determination. For example, WellnessAd AdID1 may be available in New York City. At 715 a determination may be made regarding WellnessAds (e.g., WellnessAds available for the location) that are available for the consumer's wellness issue of interest. For example, the IssueLists of the Advertisement data structures associated with WellnessAds may be compared to the IssueID (e.g., stored in the Issue database table 1319b) of the wellness issue of interest to the consumer to make this determination. For example, WellnessAd AdID1 may be available for issue IID1 (e.g., Obesity).

A determination may be made at 720 whether profile information for the consumer is available. For example, the consumer may be prompted to login to the consumers WELLNESS AD PLATFORM account at a WellnessAd kiosk. In another example, the consumer may already be logged in via a WellnessAd application on the consumers mobile device. If the consumer profile information is not available, a determination may be made at 725 whether a new consumer profile may be created. For example, a WellnessAd kiosk without a keyboard may not be able to create new consumer profiles. In one implementation, a configuration file (e.g., associated with a WellnessAd kiosk) may specify whether new consumer profiles may be created. In another implementation, the presence of a network connection may determine whether new consumer profiles may be created (e.g., a WellnessAd application running on a mobile device may be able to create new consumer profiles when a wireless network connection is available, but not when a wireless network connection is not available). If new consumer profiles may be created, the consumer may be prompted to create a new consumer profile (e.g., via a user interface of the WellnessAd application) at 730. If the consumer decides to create a new profile, the WELLNESS AD PLATFORM may also provide the consumer with an ability to unify the profile with other accounts (e.g., AdditionalProfiles) at 735. Consumer profile information may be stored in a Consumer data structure. If a new consumer profile may not be created, or if the consumer declines to create a new profile, a default WellnessAd may be selected for presentation to the consumer at 770. In one implementation, a default WellnessAd may be selected based on a default rank (e.g., default rank stored in an Advertisement data structure) associated with a WellnessAd. For example, the WellnessAd with the highest default rank may be selected for presentation to the consumer. In another implementation, a default WellnessAd may be selected based on the number of times a WellnessAd was shown. For example, the WellnessAd that was shown the fewest times this month may be selected for presentation to the consumer.

If the consumer profile information is available, a WellnessAd query may be generated based on the consumers profile information at 740. For example, the query may be constructed to select WellnessAds that the consumer may be interested in viewing. The query may be based on comparing consumer profile information in the Consumer data structure (e.g., location, preferences, demographics, additional profiles, and/or the like) and information in the Advertisement data structure. Any fields in the Consumer data structure and/or Advertisement data structure may be used to match a WellnessAd to the consumer. Furthermore, information regarding which WellnessAds have the highest impact on various types of consumers (e.g., categorized based on location, preferences, demographics, additional profiles, and/or the like) may be analyzed and may be used to provide WellnessAds that the consumer may be most interested in viewing. In situations where demographic information regarding a consumer may be unavailable, the consumers coarse demographic information (e.g., height, gender, age, and/or the like) may be determined by using a biometric information analyzing device (e.g., a camera coupled with image processing software) to provide relevant WellnessAds. For example, the query may be a SQL query substantially in the following form:

SELECT Advertisement.AdvertisementID
FROM Advertisement, Consumer
WHERE Advertisement.ContentType = Consumer.AdContentType

The query may be executed at 745, and the matching WellnessAds may be compared with advertiser campaign preferences (e.g., stored in the Advertiser data structure) at 750 to select WellnessAds that match advertiser campaign preferences (e.g., based on consumer demographic information). A determination may be made at 755 whether matching WellnessAds were found. If no matching WellnessAds were found (e.g., WellnessAds that appeal to the consumer and match advertiser campaign preferences), a default WellnessAd may be selected for presentation to the consumer at 770. If matching WellnessAds were found, the best matching advertisement may be selected at 760. In one implementation, the best matching WellnessAd may be selected based on a relevancy score (e.g., calculated based on the number of parameters that matched during the querying, the proximity of the WellnessAd AdvertiserContributionAmount to the payment amount for the wellness issue of interest, and/or the like). In another implementation, the best matching WellnessAd may be selected based on the number of times a matching WellnessAd was shown. For example, a matching WellnessAd that was shown the fewest times this month may be selected for presentation to the consumer.

A determination may be made at 775 whether the selected WellnessAd is available from a local database. If the selected WellnessAd is available from the local database, the WellnessAd may be retrieved from the local database at 780 (e.g., retrieved from a local hard drive, flash memory, and/or the like). If the selected WellnessAd is not available from the local database, the WellnessAd may be retrieved from a remote database at 790 (e.g., retrieved from an ftp server over the network, streamed from a remote site, and/or the like). For example, retrieved WellnessAd information may include information regarding a WellnessProject of interest to the consumer and how much the advertiser has contributed to the WellnessProject through the WellnessAd. This information may be of interest to the consumer and may engage the consumer more strongly with the WellnessAd.

FIG. 8 shows a logic flow diagram illustrating a transaction benefit apportionment (TBA) component 1345 in one embodiment of the WELLNESS AD PLATFORM. In one embodiment, the TBA component may be used to distribute Credits (e.g., earned by the consumer by watching WellnessAds) among appropriate beneficiaries. The Beneficiary data structure may store information regarding beneficiaries and may be in XML format substantially in the following form:

```
<XML>
<Beneficiary>
    <BeneficiaryID>BID1</BeneficiaryID>
    <BeneficiaryName>New York City</BeneficiaryName>
    <Address>123 Main St, New York, NY 11112</Address>
    <WellnessCreditAccountNumber>12345
    </WellnessCreditAccountNumber>
    <EntityType>Government</EntityType>
</Beneficiary>
<Beneficiary>
    <BeneficiaryID>BID2</BeneficiaryID>
    <BeneficiaryName>Local Wellness Clinic</BeneficiaryName>
    <Address>456 Main St, New York, NY 11112</Address>
    <WellnessCreditAccountNumber>23456
    </WellnessCreditAccountNumber>
    <EntityType>Non-profit</EntityType>
    <WellnessType>Clinic</WellnessType>
<Industry>Disease Testing</Industry>
</Beneficiary>
<Beneficiary>
    <BeneficiaryID>BID3</BeneficiaryID>
    <BeneficiaryName>Diabetes Care Center</BeneficiaryName>
    <Address>567 Main St, New York, NY 11112</Address>
    <WellnessCreditAccountNumber>34567
    </WellnessCreditAccountNumber>
    <EntityType>Corporation</EntityType>
    <WellnessType>Educating Newly Diagnosed Diabetics
    </WellnessType>
    <Industry>Diabetes Care</Industry>
</Beneficiary>
</XML>
```

The Beneficiary data structure may be stored in the Beneficiary database table 1319f. A beneficiary may have a BeneficiaryID that uniquely identifies the beneficiary. The Beneficiary data structure may have a CreditAccountNumber (e.g., a bank account, a deposit account number, and/or the like) associated with the beneficiary. The CreditAccountNumber may be used to facilitate receiving Credits allocated (e.g., by the consumer, by the WellnessFacilitator, and/or the like) to the beneficiary (e.g., to credit the beneficiary's account with Credits). The Beneficiary data structure may have information regarding the beneficiary such as the beneficiary's name, address, entity type, wellness type, industry, and/or the like. For example, the WellnessType may indicate whether the beneficiary is associated with diabetes, obesity, cardiovascular diseases, health education, and/or the like. Information regarding beneficiaries may be presented to the consumer and/or used to assist the consumer in selecting the desired beneficiaries. For example, if the consumer wants to donate Credits to a local wellness clinic, the WELLNESS AD PLATFORM may compare the consumers specified parameters (e.g., input via a user interface of the WellnessAd application) to the Address, WellnessType and Industry fields of the Beneficiary data structure (e.g., using a SQL query) and present the consumer with a list of beneficiaries that may include the “Diabetes Care Center” beneficiary BID3.

In FIG. 8, the TBA component may await until a transaction involving Credits is available at 805 (e.g., await a notification). Information regarding the transaction may be retrieved at 810. Transaction information may be retrieved from a transaction data structure describing the transaction and may be received along with the notification. For example, the transaction data structure may be in XML format substantially in the following form:

```
<XML>
      <Transaction>
            <TransactionID>TID1</TransactionID>
            <Location>LID1</Location>
            <Issue>IID1</Issue>
            <PaymentAmount>$3</PaymentAmount>
            <PaymentType>WellnessAd</PaymentType>
            <Advertisement>AdID1</Advertisement>
            <Advertiser>AdvID1</Advertiser>
            <Consumer>CID1</Consumer>
            <ConsumerSelectedBeneficiary>
                  <Beneficiary>BID3</Beneficiary>
                  <BeneficiaryAmount>5%</BeneficiaryAmount>
            </ConsumerSelectedBeneficiary>
      </Transaction>
</XML>
```

The issue type may be determined 815 by examining (e.g., using an XML parser) the transaction data structure (e.g., the issue type is IID1). The beneficiaries may be queried based on the issue type at 820. In one implementation, the beneficiaries associated with an issue type may be determined based on the information in the Issue database (e.g., using a SQL query). The beneficiaries associated with an issue type may be determined based on the consumer selected beneficiaries in the transaction data structure (e.g., using an XML parser). A determination may be made at 825 whether beneficiary results exist. If beneficiaries exist for the issue type, a beneficiaries apportionment table (e.g., created based on BeneficiaryAmount information in the transaction data structure) may be loaded for determined beneficiaries at 830. If no beneficiary results exist, a default beneficiaries apportionment table (e.g., based on a configuration file) may be loaded at 840.

A determination may be made at 850 whether the transaction is a cash transaction (e.g., PaymentType is Cash, which may include cash payments, credit card payments, bank account payments, and/or the like), or a WellnessAd viewing transaction (e.g., PaymentType is WellnessAd). If the PaymentType is Cash, the cash value amount of the payment may be parsed at 855 (e.g., from the transaction data structure). If the PaymentType is WellnessAd, the transaction activity value of the payment may be queried at 860. For example, the transaction activity value of the payment may be determined by examining the AdvertiserContributionAmount of the Advertisement data structure associated with the WellnessAd.

A determination may be made at 865 whether there are more beneficiaries that should receive payment for the transaction (e.g., based on the list of beneficiaries in the beneficiaries apportionment table). If there are more beneficiaries that should receive payment, the beneficiary's deposit account may be determined at 870. The beneficiary's deposit account may be determined by examining the CreditAccountNumber field of the Beneficiary data structure associated with the beneficiary. The beneficiary apportionment of payment value amount may be determined at 875 (e.g., based on the values in the beneficiaries apportionment table). In one implementation, the values in the beneficiaries apportionment table may be percentages of payment that should be allocated to the beneficiaries. In another implementation, the values in the beneficiaries apportionment table may be dollar amounts that should be allocated to the beneficiaries. A determination may be made at 880 whether sufficient payment has been received to provide the determined apportionment to the beneficiary, and an error notification may be generated at 885 if sufficient payment has not been received. If sufficient payment has been received, the deposit of the determined apportionment may be effected at 890 (e.g., the deposit account of the beneficiary may be credited). The deposit may be a wire transfer transmitted in XML format substantially in the following form:

```
<XML>
      <WireTransfer>
            <From>
                  <EntityID>ID778</EntityID>
                  <AccountNumber>846432</AccountNumber>
            </From>
            <To>
                  <EntityID>ID987</EntityID>
                  <BankName>Bank1</BankName>
                  <BankAddress>address1</BankAddress>
                  <BankRoutingNumber>444555666
                  </BankRoutingNumber>
                  <AccountNumber>666555444</AccountNumber>
            </To>
            <TransferAmount>$100</TransferAmount>
      </WireTransfer>
</XML>
```

If there are more beneficiaries that should receive payment for the transaction, the next beneficiary may be paid in a similar manner. If there are no more beneficiaries that should receive payment for the transaction, the TBA component may move on to the next available transaction.

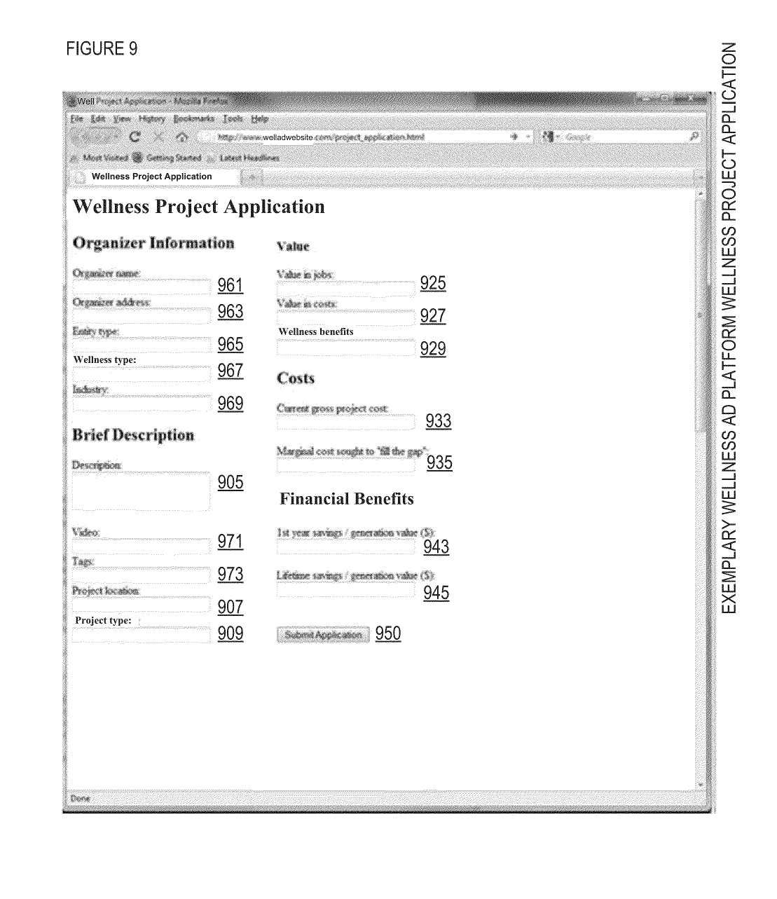

FIG. 9 shows a screen shot diagram illustrating a Wellness Project Application in one embodiment of the WELLNESS AD PLATFORM. Information in an application supplied by an applicant (e.g., a fulfillment partner) that would like to obtain funding for a project may be used to determine whether the project should be approved as a selected WellnessProject. As illustrated in FIG. 9, the applicant may provide information regarding the WellnessProject organizer. The Organizer Information section of the application may include organizer name 961, organizer address 963, entity type 965, wellness type 967, industry 969, and/or the like. The Organizer Information section data may be used to match advertisers with WellnessProjects, to display information regarding the project organizer to WellnessAd consumers, and/or the like. For example, the Organizer Information section data may be used to connect an advertiser with non-profits that work on diabetes testing (e.g., by matching the EntityType and Industry fields of the ProjectApplication data structure). The applicant may provide a brief description of the project in the Brief Description section. The Brief Description section may include a description of the project 905, a video describing or highlighting aspects of the project 971, tags associated with the project 973, a project location 907, project type 909, and/or the like. The Brief Description section data may be used to match advertisers with WellnessProjects, to display information regarding WellnessProjects to WellnessAd consumers, and/or the like. For example, the Tags field of the ProjectApplication data structure may be used to match advertisers with WellnessProjects associated with certain tags (e.g., obesity). In another example, the Project Type field of the ProjectApplication data structure may be used to match advertisers with non-profit WellnessProjects in a specific area (e.g., diabetes testing). The Value section may include a value in jobs 925, a value in costs 927, wellness benefits 929, and/or the like. The applicant may provide costs associated with the project in the Costs section. The Costs section may include a current gross project cost 933 and a margin cost sought to “fill the gap” 935. The applicant may describe financial benefits associated with the project in the Financial Benefits section. The Financial Benefits section may include 1st year saving/generation value 943 and lifetime savings/generation value 945.

The applicant may submit the application by clicking the Submit Application button 950. The information submitted by the applicant may be stored in a ProjectApplication data structure and may be in XML format substantially in the following form:

```
<XML>
<ProjectApplication>
          <ProjectApplicationID>PAID1</ProjectApplicationID>
          <ProjectApplicationDate>November 1, 2011
          </ProjectApplicationDate>
          <OrganizerInformation>
                <OrganizerID>OID2</OrganizerID>
                <OrganizerName>Healthy Community Clinics
                </OrganizerName>
                <Address>456 Main St, New York, NY 11112
                </Address>
                <EntityType>Non-profit</EntityType>
                <WellnessType>Wellness Clinic</WellnessType>
                <Industry>Disease Testing</Industry>
          </OrganizerInformation>
          <BriefDescription>
                <Description>Project description</Description>
                <Video>video_file.avi</Video>
                <Tags>tag1,tag2,tag3</Tags>
                <Location>Project location</Location>
                <ProjectType>Diabetes Testing, Non-profit
                </ProjectType>
          </BriefDescription>
          <Value>
                <Jobs>100<Jobs>
                <Costs>$1,000</Costs>
                <WellnessBenefits>100 disease diagnoses
                </WellnessBenefits>
          </Value>
          <Costs>
                <Gross>$2,000,000</Gross>
                <Marginal>$200,000</Marginal>
          </Costs>
          <FinancialBenefits>
                <FirstYearToGenerationValue>10
                </FirstYearToGenerationValue>
                <LifetimeToGenerationValue>12
                </LifetimeToGenerationValue>
          </FinancialBenefits>
</ProjectApplication>
<ProjectApplication>
          ...
</ProjectApplication>
</XML>
```

The ProjectApplication data structure may be stored in the Project Application database table 1319g. The project application may have a ProjectApplicationID that uniquely identifies the project application.

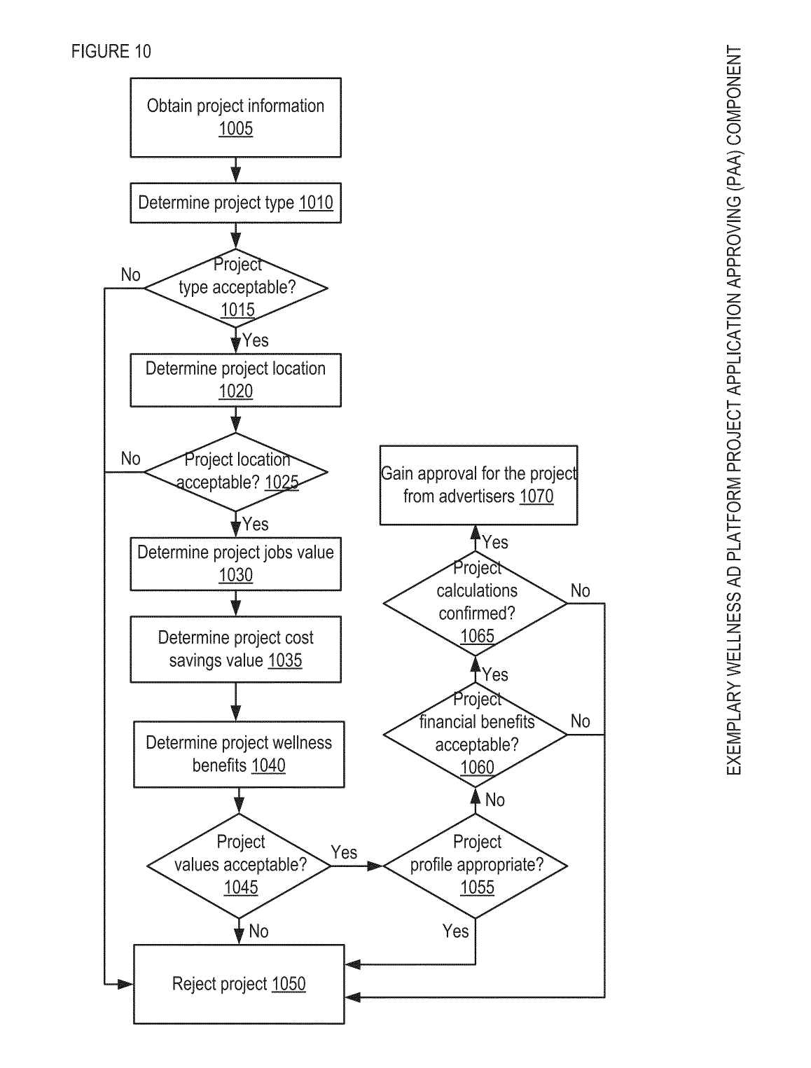

FIG. 10 shows a logic flow diagram illustrating a project application approving (PAA) component 1346 in one embodiment of the WELLNESS AD PLATFORM. In FIG. 10, information regarding a project may be retrieved from the ProjectApplication data structure at 1005. The project type may be determined at 1010. The ProjectType field of the ProjectApplication data structure may be examined (e.g., using an XML parser) to make this determination. For example, the ProjectType field of the ProjectApplication data structure may indicate that the project is for a non-profit that will conduct diabetes testing. A determination may be made at 1015 whether the project type is acceptable. In one embodiment, acceptable projects may be those that are associated with a preapproved list of issues (e.g., disease testing, disease treatment, mobile health clinics, fitness zones, prenatal care, underfunded technologies, healthy meals, healthcare infrastructure). In another embodiment, acceptable projects may be those associated with a non-profit (e.g., a certain percentage of funding for the project should be allocated to a charity). If the project type is not acceptable, the project may be rejected at 1050.

If the project type is acceptable, the project location may be determined at 1020. The Location field of the ProjectApplication data structure may be examined to make this determination. For example, the Location field of the ProjectApplication data structure may indicate that the project location is San Francisco. A determination may be made at 1025 whether the project location is acceptable. In one embodiment, this determination may be made based on the WellnessFacilitator's experience with the location. For example, the number of previous WellnessProjects performed at the location, how productive those WellnessProjects have been, the socioeconomic factors associated with the location, the need for a WellnessProject at the location compared to other locations, the level of community support for the WellnessProject, and/or the like may be considered in making this determination (e.g., based on a score that may be compared to a threshold value). In another embodiment, this determination may be made based on the location preferences of the advertisers. For example, Locations field of the ProjectsSupported field of the Advertiser data structure may be examined to determine locations where the advertisers are willing to support WellnessProjects, and the project location may be acceptable if it falls within one of the advertiser supported locations. In another example, location preferences of the advertisers may be used to rank projects in order of priority (e.g., instead of being rejected, a project that is not in an advertiser supported location may be accepted but ranked lower, so it may take longer for the project to obtain funding). If the project location is not acceptable, the project may be rejected at 1050.

If the project location is acceptable, the project jobs value may be determined at 1030. The Jobs field of the ProjectApplication data structure may be examined to make this determination. For example, the Jobs field of the ProjectApplication data structure may indicate that the project is expected to generate 100 jobs. The project cost saving value may be determined at 1035. The Costs field of the ProjectApplication data structure may be examined to make this determination. For example, the Costs field of the ProjectApplication data structure may indicate that the project is expected to generate $1,000 in savings (e.g., per month). The project wellness benefits may be determined at 1040. The WellnessBenefits field of the ProjectApplication data structure may be examined to make this determination. For example, the WellnessBenefits field of the ProjectApplication data structure may indicate that the project is expected to result in diagnoses of diabetes for 100 people (e.g., per year).

The project's qualification for inclusion into the WELLNESS AD PLATFORM may be assessed based on the determined project values at 1045. The project's values may be compared (e.g., using minimum values, maximum values, ranges, qualitative values, and/or the like) to specified parameters (e.g., specified by the WellnessFacilitator and stored in a configuration file) to make this determination. For example, the WellnessFacilitator may specify that projects that create at least 10 jobs, produce cost saving of at least $500, and result in diagnoses of at least 50 people may qualify for inclusion into the WELLNESS AD PLATFORM (e.g., 10 times the benefit as compared to an advertiser's cost to fund the WellnessAd and project). If the project values are not acceptable, the project may be rejected at 1050. For example, an error message may be generated (e.g., “sorry your project does not qualify”), and the applicant may be invited to adjust project parameters and to resubmit the project application. To aid applicants with submitting successful project applications, the WELLNESS AD PLATFORM may aggregate and analyze information regarding project application submissions and provide applicants with feedback. The WELLNESS AD PLATFORM may track approved and/or rejected project applications, information regarding submissions (e.g., project location, demographics, parameters, and/or the like), and/or the like, and analyze this data to determine which project applications are likely to be approved. For example, the WELLNESS AD PLATFORM may generate reports with such analysis, create an index of successful locations, demographics, parameters, and/or the like, and provide this information (e.g., via a website) to the applicants. In another example, the WELLNESS AD PLATFORM may detect that a project application contains a field value (e.g., total cost more than $1M) associated with high rejection rate and may inform the applicant that project applications with such field values are likely to be rejected. In another embodiment, these aggregated values may comprise a published index showing the most actively approved of areas, the projects creating the greatest positive impact, etc.

If the project values are acceptable, a determination may be made at 1055 whether the project's profile is acceptable. In one embodiment, project costs may be examined to determine whether the project costs are too high. The Costs such as Gross (e.g., total cost), Marginal (e.g., WellnessFacilitator's contribution), and/or the like fields of the ProjectApplication data structure may be examined and compared to predetermined cost limits (e.g., specified by the WellnessFacilitator) to make this determination. For example, the WellnessFacilitator may specify that the WellnessFacilitator may invest a maximum of $500,000 into a project and/or project component. In another embodiment, project costs may be examined to determine whether the funding provided for the project by the WellnessFacilitator would indeed be gap funding. For example, the WellnessFacilitator may specify that the WellnessFacilitator may contribute no more than 10% of a project's and/or a project component's total cost. If the project's profile is not acceptable, the project may be rejected at 1050.

If the project's profile is acceptable, project financial benefits may be examined at 1060. The financial benefits such as FirstYearToGenerationValue (e.g., first year project benefits), LifetimeToGenerationValue (e.g., lifetime project benefits), and/or the like fields of the ProjectApplication data structure may be examined and compared to predetermined benefits restrictions (e.g., specified by the WellnessFacilitator) to make this determination. For example, the WellnessFacilitator may specify that the WellnessFacilitator may invest in projects that produce benefits of (e.g., during the first year, during lifetime, and/or the like) a minimum of 10 to 1 (e.g., a dollar of investment generates at least 10 dollar savings in future health costs by, e.g., disease prevention, and/or the like). If the project financial benefits are not acceptable, the project may be rejected at 1050.

If the project financial benefits are acceptable, a determination may be made at 1065 whether project calculations provided by the applicant may be confirmed. For example, the standards, calculation methodologies, estimated project values (e.g., costs, cost saving, wellness benefits, financial benefits), calculations, and/or the like may be analyzed by the WellnessFacilitator and compared to benchmarks to determine that they are applicable, recalculated to confirm that the data is correct, assessed in terms of being verifiable in the real world, and/or the like. In one embodiment, if any of the project calculations provided by the applicant are unreliable, the project may be rejected at 1050. In another embodiment, a confirmation score may be generated based on the analysis and compared to a threshold value to determine whether the project calculations provided by the applicant are reliable, and, if not, the project may be rejected at 1050.

If the project calculations provided by the applicant are confirmed, the project may be sent for approval to the advertisers at 1070. In one embodiment, the project may be added to a list of potential projects. The potential projects may be provided to advertisers for approval. For example, an advertiser may search the list of potential projects for projects of interest (e.g., the advertiser may be interested in projects to diagnose diabetes and improve prenatal care in the greater San Francisco area) and may approve and indicate a desire to support the project. Upon approval by one or more advertisers, the applicant may become a beneficiary in the WELLNESS AD PLATFORM.

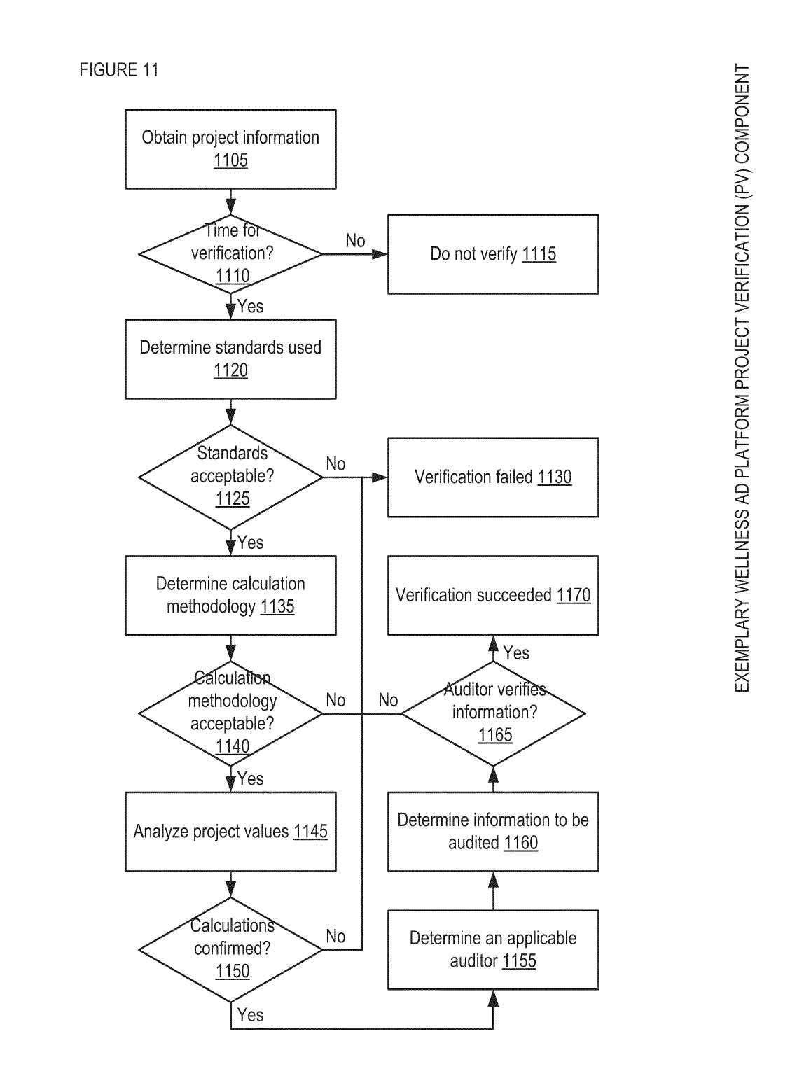

FIG. 11 shows a logic flow diagram illustrating a project verification (PV) component 1347 in one embodiment of the WELLNESS AD PLATFORM. In FIG. 11, project information may be obtained at 1105. For example, information regarding the standards, calculation methodologies, actual project values (e.g., costs, cost saving, wellness benefits, financial benefits), calculations, and/or the like may be obtained from the fulfillment partner. A determination may be made at 1110 whether verification should be performed. For example, the WellnessFacilitator may specify, as part of an agreement to provide funding for a WellnessProject, that the fulfillment partner should provide periodic (e.g., annual) data regarding actual progress made by the fulfillment partner with regard to the WellnessProject for verification by the WellnessFacilitator. If it is not yet time for verification, verification is not performed 1115. If it is time for verification, verification may be performed using the obtained project information.

Standards used by the fulfillment partner may be determined at 1120. In one embodiment, standards may include how data is obtained. For example, data may be obtained from the fulfillment partner, from a subcontractor used by the fulfillment partner, from a reporting document (e.g., a Securities and Exchange Commission (SEC) filing), from a report by a governmental agency (e.g., a National Institute of Health (NIH) report), and/or the like. In another embodiment, standards may include assumption made by the fulfillment partner. For example, assumptions may include data such as how much money is saved in 10 years by early detection of diabetes in a person who would not otherwise be aware of the disease. In another example, assumptions may include data such as how many indirect jobs (e.g., clinical supplies manufacturing jobs) may be generated by operating a mobile health clinic. A determination may be made at 1125 whether the standards used by the fulfillment partner are acceptable. For example, such a determination may be made based on accepted industry practice (e.g., whether a particular type of information is typically obtained from a source proposed by the fulfillment partner), average of values obtained from other projects (e.g., how many indirect jobs are assumed to be generated on average by other mobile health clinic projects), governmental data (e.g., do the assumptions match data provided by a governmental agency), and/or the like. If the standards are not acceptable, the verification may fail at 1130. If the verification fails, the fulfillment partner may be invited to revise its standards and resubmit data for verification, may be disqualified to participate in the WELLNESS AD PLATFORM, and/or the like.

If the standards are acceptable, calculation methodologies used by the fulfillment partner may be determined at 1135. In one embodiment, calculation methodologies may include calculators used by the fulfillment partner. For example, in determining the number of obese people helped by a WellnessProject, the Body Mass Index (BMI) calculator used by the fulfillment partner may be assessed. A determination may be made at 1140 whether the calculation methodologies used by the fulfillment partner are acceptable. For example, such a determination may be made based on calculators provided by various third parties (e.g., do the values produced by the fulfillment partner's BMI calculator match those provided by the NIH BMI Calculator). If the calculation methodologies used by the fulfillment partner are not acceptable, the verification may fail at 1130. If the verification fails, the fulfillment partner may be invited to revise its calculation methodologies and resubmit data for verification, may be disqualified to participate in the WELLNESS AD PLATFORM, and/or the like.

If the calculation methodologies used by the fulfillment partner are acceptable, project values may be analyzed at 1145. For example, such project values may include costs to complete and/or operate a WellnessProject, cost savings produced by the WellnessProject, wellness benefits produced by the WellnessProject (e.g., the number of people who got early prenatal care at a mobile health clinic, the number of people who redeemed vouchers for healthy meals, the number of diabetes tests performed, the number of fitness zones constructed, and/or the like), financial benefits produced by the WellnessProject. In one embodiment, the project values may be compared against estimated and/or promised project values provided by the fulfillment partner (e.g., to see whether the project values are appropriate). In another embodiment, the project values may be compared against average values obtained from other projects. A determination may be made at 1150 whether the calculations using the project values may be confirmed. For example, spreadsheets submitted by the fulfillment partner may be analyzed to determine whether appropriate project values have been used and/or whether the calculations performed on the project values are correct. If the calculations may not be confirmed, the verification may fail at 1130. If the verification fails, the fulfillment partner may be invited to revise its project values and/or calculations and resubmit data for verification, may be disqualified to participate in the WELLNESS AD PLATFORM, and/or the like.

If the calculations are confirmed by the WellnessFacilitator, the WellnessFacilitator may determine an applicable auditor at 1155 to audit selected information 1160. Any information, such as information regarding the standards, calculation methodologies, actual project values (e.g., costs, cost saving, wellness benefits, financial benefits), calculations, and/or the like may be selected by the WellnessFacilitator to be audited and provided to one or more applicable auditors. The WellnessFacilitator may determine the applicable auditors based on the selected information. For example, an auditor that specializes in auditing the number of people that visit a medical facility may be selected to audit the number of prenatal visits at a mobile health clinic. A determination may be made at 1165 whether the auditor verifies the provided information. If the auditor does not verify the provided information, the fulfillment partner may be invited to revise and resubmit data for verification, may be disqualified to participate in the WELLNESS AD PLATFORM, and/or the like. If the auditor verifies the provided information, the verification succeeds at 1170.

Generally speaking, ensuring that the selected and funded projects both (i) report measurable success outcomes and (ii) provide for and/or allow third-party, objective verification or confirmation of those outcomes is believed to be an important motivational and trust-building aspect of a preferred embodiment of a WELLNESS AD PLATFORM. In some embodiments, the verification function (including, preferably, audit by a pre-selected and screened auditor having qualifications and experience appropriate to the particular wellness project) may result in several potentially important outcomes. These may be envisioned as following element 1165 in FIG. 11 or after resubmission of the data as discussed above. For example, the verification response 582 of FIG. 5 (or, more generally, the report generated in step 7 of FIG. 1) can be received and stored by the WellnessFacilitator and used, for example, as a factor in determining future interactions with (and ratings of) the fulfillment partner. It may be desirable, and is within the scope of the inventions disclosed herein, to pass the report or verification response (or, more generally, some message comprising at least some of such data) to the advertiser (with more or less anonymizing of data to handle privacy and related concerns, as desired). In one embodiment, the particular wellness project or fulfillment partner may be disqualified from receiving future funding via the WELLNESS AD PLATFORM if the verification is not complete and acceptable (or if the verified levels of results do not, individually or when aggregated, achieve predefined acceptable thresholds). Alternatively, the project or the fulfillment partner may be marked or flagged as qualified to receive further funding via the WELLNESS AD PLATFORM only if the report or verification indication indicates that a selected portion of the project verification data has been verified. Intermediate scrutiny alternatives are also envisioned. In one embodiment, a fulfillment partner or project which does not pass an initial audit or verification may be placed under increased scrutiny for the duration of the project or in the next funding scenario and required to verify at an increased level. In another embodiment, a fulfillment partner with a particularly strong record of performance may be selectively audited at a less intrusive level for pre-determined project types. Audit or verification processes may be implemented on different timelines as well. In some embodiments, in selected projects (or with selected fulfillment partners) audit, confirmation or verification may occur only at the completion of the project or the completion of the display period associated with particular advertising. In other embodiments, audit, confirmation or verification may occur during the display period associated with particular advertising, for example, after one third of the placed advertisement availabilities have occurred, and may occur more than once.

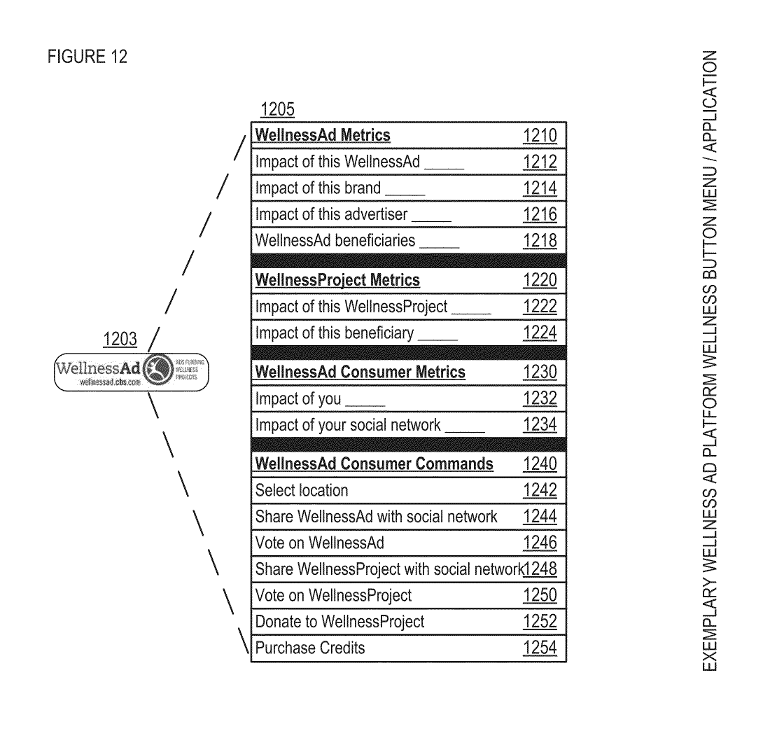

FIG. 12 shows a screen shot diagram illustrating a WellnessButton Menu/Application in one embodiment of the WELLNESS AD PLATFORM. The WellnessButton Menu/Application may provide metrics regarding a WellnessAd, a WellnessProject, and/or the like, may provide the metrics regarding a WellnessAd consumer, the consumers social network, and/or the like, may facilitate action by the consumer, and/or the like. The WellnessButton Menu/Application may be associated with TV, web, print, radio, and/or the like WellnessAds, WellnessProject information, and/or the like. In one embodiment, a WellnessAd may be TV or web-based, and a WellnessButton 1203 may be displayed along with the WellnessAd (e.g., overlaying the WellnessAd, next to the WellnessAd, and/or the like). The user may activate the WellnessButton (e.g., by right-clicking on the WellnessButton, by using a button on a TV remote control) to display the WellnessButton Menu/Application 1205. In another embodiment, a WellnessAd may be a print or a billboard WellnessAd, and the WellnessButton 1203 may include a barcode that may be scanned (e.g., by the WellnessAd barcode application) to display the WellnessButton Menu/Application 1205 on a screen (e.g., of a mobile device). In yet another embodiment, a WellnessAd may be a radio WellnessAd, which may include an audio mnemonic. The audio mnemonic may be identified (e.g., by the WellnessAd barcode application) to display the WellnessButton Menu/Application 1205 on a screen (e.g., of a mobile device).

The WellnessButton 1203 may facilitate identifying an advertisement as a WellnessAd. For example, verified WellnessAds may display the WellnessButton to indicate their status as verified WellnessAds. In one embodiment, aspects of the WellnessButton (e.g., color, size, shape, and/or the like) may vary over time (e.g., daily, weekly, monthly, and/or the like) to discourage unauthorized use. In another embodiment, aspects of the WellnessButton Menu/Application 1205 may vary over time, and the WellnessButton Menu/Application may not load unless the WellnessAd is a verified WellnessAd. For example, if an advertisement is not verified a message indicating this may be displayed (e.g., “This advertisement is not a verified WellnessAd!”).

The WellnessButton Menu/Application may provide WellnessAd metrics 1210. The WellnessAd metrics may include the impact of the WellnessAd 1212, the brand 1214, and/or the advertiser 1216. For example, the impact of the WellnessAd, the brand, and/or the advertiser may be measured using metrics such as jobs created, credits generated, money saved, number of diagnoses, and/or the like (e.g., confirmed and/or verified by the WellnessFacilitator and/or an auditor). The WellnessAd metrics may include WellnessAd beneficiaries 1218 of the funds generated from displaying the WellnessAd (e.g., WellnessProject organizers, WellnessProjects, and/or the like). For example, WellnessAd consumers may view the WellnessAd beneficiaries and/or how much funding their WellnessProjects received from displaying the WellnessAd.

The WellnessButton Menu/Application may provide WellnessProject metrics 1220. The WellnessProject metrics may include the impact of a WellnessProject 1222. For example, the impact of the WellnessProject may be measured using metrics such as jobs created, credits generated, money saved, number of diagnoses, and/or the like. The WellnessProject metrics may include the impact of a beneficiary 1224. For example, the impact of the beneficiary may be calculated as the aggregate impact of WellnessProjects associated with the beneficiary.

The WellnessButton Menu/Application may provide WellnessAd consumer metrics 1230. The WellnessAd consumer metrics may include the impact of a WellnessAd consumer 1232. For example, the impact of the WellnessAd consumer may show what kind of impact the consumers donations and/or WellnessAd viewing has had (e.g., during the month, overall, and/or the like). In another example, a portion of the impact generated by the people in the consumers social network may be attributed to the consumer (e.g., 5% of the generated impact). The WellnessAd consumer metrics may include the impact of a WellnessAd consumers social network 1234. For example, the impact of people in the consumers social network (e.g., based on contacts from Facebook, LinkedIn, instant messenger buddy lists, twitter, email, and/or the like) may be aggregated to show the collective impact. In another example, the impacts of people in the consumers social network may be displayed individually (e.g., impacts of five contacts with the highest impacts).

The WellnessButton Menu/Application may carry out WellnessAd consumer commands 1240. The WellnessAd consumer commands may include a command to select location 1242. For example, the impact of a WellnessAd, an advertiser, a WellnessProject, and/or the like may be calculated with respect to a location. Selecting a location facilitates viewing the impact with respect to the selected location. The WellnessAd consumer commands may include a command to share a WellnessAd with social network 1244 and/or a command to share a WellnessProject with social network 1248. For example, a WellnessAd consumer may wish to share a WellnessAd and/or a WellnessProject (e.g., a video with information regarding the WellnessProject) of interest with the consumer's social network (e.g., the consumer may feel strongly about a WellnessProject supported by the WellnessAd, the consumer may wish to increase the impact of the consumer's social network, the consumer may wish people in the consumer's social network to vote for the WellnessProject, and/or the like). Accordingly, the consumer may share the WellnessAd and/or the WellnessProject (e.g., by sending a link to the WellnessAd and/or to the WellnessProject) with the consumer's social network (e.g., by posting the link to the consumer's Facebook wall, by emailing the link, by sending a text message with the link, and/or the like). The WellnessAd consumer commands may include a command to vote on a WellnessAd 1246 and/or to vote on a WellnessProject 1250. For example, the WellnessFacilitator may ask WellnessAd consumers to vote on whether a project should be allowed to become a WellnessProject, which WellnessProjects should get priority with regard to obtaining funding, and/or the like (e.g., based on a video regarding the project). Thus, WellnessAd consumers may have a say regarding which projects should become funded WellnessProjects and/or the order in which WellnessProjects should be funded. The WellnessAd consumer commands may include a command to donate to a WellnessProject 1252. For example, if a WellnessAd consumer feels strongly about a WellnessProject, the consumer may donate to the WellnessProject to help generate funding for the WellnessProject quicker. The consumer may donate to the WellnessProject by paying (e.g., with a credit card), by donating the consumer's Credits, and/or the like. The WellnessAd consumer commands may include a command to purchase Credits 1254. The purchased Credits may be donated to a WellnessProject, friend, charity, and/or the like.

### WELLNESS AD PLATFORM Controller

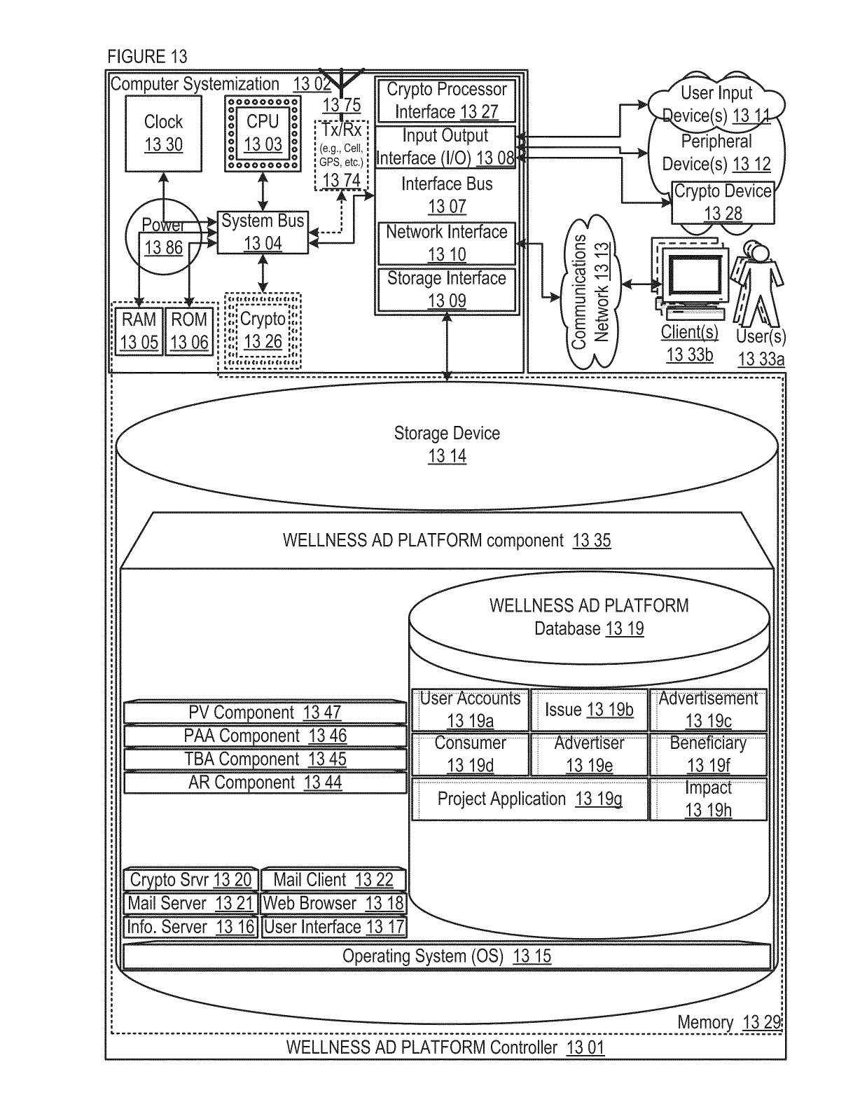

FIG. 13 shows a block diagram illustrating embodiments of a WELLNESS AD PLATFORM controller. In this embodiment, the WELLNESS AD PLATFORM controller 1301 may serve to aggregate, process, store, search, serve, identify, instruct, generate, match, and/or facilitate interactions with a computer through a variety of information technologies, and/or other related data.

Typically, users, which may be people and/or other systems, may engage information technology systems (e.g., computers) to facilitate information processing. In turn, computers employ processors to process information; such processors 1303 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 1329 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the WELLNESS AD PLATFORM controller 1301 may be connected to and/or communicate with entities such as, but not limited to: one or more users from user input devices 1311; peripheral devices 1312; an optional cryptographic processor device 1328; and/or a communications network 1313.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The WELLNESS AD PLATFORM controller 1301 may be based on computer systems that may comprise, but are not limited to, components such as: a computer systemization 1302 connected to memory 1329.

### Computer Systemization

A computer systemization 1302 may comprise a clock 1330, central processing unit (“CPU(s)” and/or “processor(s)” (these terms are used interchangeable throughout the disclosure unless noted to the contrary)) 1303, a memory 1329 (e.g., a read only memory (ROM) 1306, a random access memory (RAM) 1305, etc.), and/or an interface bus 1307, and most frequently, although not necessarily, are all interconnected and/or communicating through a system bus 1304 on one or more (mother)board(s) 1302 having conductive and/or otherwise transportive circuit pathways through which instructions (e.g., binary encoded signals) may travel to effectuate communications, operations, storage, etc. The computer systemization may be connected to a power source 1386; e.g., optionally the power source may be internal. Optionally, a cryptographic processor 1326 and/or transceivers (e.g., ICs) 1374 may be connected to the system bus. In another embodiment, the cryptographic processor and/or transceivers may be connected as either internal and/or external peripheral devices 1312 via the interface bus I/O. In turn, the transceivers may be connected to antenna(s) 1375, thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing WELLNESS AD PLATFORM controller to determine its location)); Broadcom BCM4329FKUBG transceiver chip (e.g., providing 802.11n, Bluetooth 2.1+EDR, FM, etc.); a Broadcom BCM4750IUB8 receiver chip (e.g., GPS); an Infineon Technologies X-Gold 618-PMB9800 (e.g., providing 2G/3G HSDPA/HSUPA communications); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 1329 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall; IBM's and Sony's Cell processor; Intel's Celeron, Core (2) Duo, Itanium, Pentium, Xeon; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the WELLNESS AD PLATFORM controller and beyond through various interfaces. Should processing requirements dictate a greater amount speed and/or capacity, distributed processors (e.g., Distributed WELLNESS AD PLATFORM), mainframe, multi-core, parallel, and/or super-computer architectures may similarly be employed. Alternatively, should deployment requirements dictate greater portability, smartphones may be employed.

Depending on the particular implementation, features of the WELLNESS AD PLATFORM may be achieved by implementing a microcontroller such as CAST's R8051XC2 microcontroller; Intel's MCS 51 (i.e., 8051 microcontroller); and/or the like. Also, to implement certain features of the WELLNESS AD PLATFORM, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the WELLNESS AD PLATFORM component collection (distributed or otherwise) and/or features may be implemented via the microprocessor and/or via embedded components; e.g., via ASIC, coprocessor, DSP, FPGA, and/or the like. Alternately, some implementations of the WELLNESS AD PLATFORM may be implemented with embedded components that are configured and used to achieve a variety of features or signal processing.

Depending on the particular implementation, the embedded components may include software solutions, hardware solutions, and/or some combination of both hardware/software solutions. For example, WELLNESS AD PLATFORM features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the WELLNESS AD PLATFORM features. A hierarchy of programmable interconnects allow logic blocks to be interconnected as needed by the WELLNESS AD PLATFORM system designer/administrator, somewhat like a one-chip programmable breadboard. An FPGA's logic blocks can be programmed to perform the operation of basic logic gates such as AND, and XOR, or more complex combinational operators such as decoders or mathematical operations. In most FPGAs, the logic blocks also include memory elements, which may be circuit flip-flops or more complete blocks of memory. In some circumstances, the WELLNESS AD PLATFORM may be developed on regular FPGAs and then migrated into a fixed version that more resembles ASIC implementations. Alternate or coordinating implementations may migrate WELLNESS AD PLATFORM controller features to a final ASIC instead of or in addition to FPGAs. Depending on the implementation all of the aforementioned embedded components and microprocessors may be considered the “CPU” and/or “processor” for the WELLNESS AD PLATFORM.

### Power Source

The power source 1386 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 1386 is connected to at least one of the interconnected subsequent components of the WELLNESS AD PLATFORM thereby providing an electric current to all subsequent components. In one example, the power source 1386 is connected to the system bus component 1304. In an alternative embodiment, an outside power source 1386 is provided through a connection across the I/O 1308 interface. For example, a USB and/or IEEE 1394 connection carries both data and power across the connection and is therefore a suitable source of power.

### Interface Adapters

Interface bus(ses) 1307 may accept, connect, and/or communicate to a number of interface adapters, conventionally although not necessarily in the form of adapter cards, such as but not limited to: input output interfaces (I/O) 1308, storage interfaces 1309, network interfaces 1310, and/or the like. Optionally, cryptographic processor interfaces 1327 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 1309 may accept, communicate, and/or connect to a number of storage devices such as, but not limited to: storage devices 1314, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 1310 may accept, communicate, and/or connect to a communications network 1313. Through a communications network 1313, the WELLNESS AD PLATFORM controller is accessible through remote clients 1333b (e.g., computers with web browsers) by users 1333a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed WELLNESS AD PLATFORM), architectures may similarly be employed to pool, load balance, and/or otherwise increase the communicative bandwidth required by the WELLNESS AD PLATFORM controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 1310 may be used to engage with various communications network types 1313. For example, multiple network interfaces may be employed to allow for the communication over broadcast, multicast, and/or unicast networks.

Input Output interfaces (I/O) 1308 may accept, communicate, and/or connect to user input devices 1311, peripheral devices 1312, cryptographic processor devices 1328, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 1311 often are a type of peripheral device 512 (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 1312 may be connected and/or communicate to I/O and/or other facilities of the like such as network interfaces, storage interfaces, directly to the interface bus, system bus, the CPU, and/or the like. Peripheral devices may be external, internal and/or part of the WELLNESS AD PLATFORM controller. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices 528), force-feedback devices (e.g., vibrating motors), network interfaces, printers, scanners, storage devices, transceivers (e.g., cellular, GPS, etc.), video devices (e.g., goggles, monitors, etc.), video sources, visors, and/or the like. Peripheral devices often include types of input devices (e.g., cameras).

It should be noted that although user input devices and peripheral devices may be employed, the WELLNESS AD PLATFORM controller may be embodied as an embedded, dedicated, and/or monitor-less (i.e., headless) device, wherein access would be provided over a network interface connection.

Cryptographic units such as, but not limited to, microcontrollers, processors 1326, interfaces 1327, and/or devices 1328 may be attached, and/or communicate with the WELLNESS AD PLATFORM controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other commercially available specialized cryptographic processors include: Broadcom's CryptoNetX and other Security Processors; nCipher's nShield; SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

### Memory

Generally, any mechanization and/or embodiment allowing a processor to affect the storage and/or retrieval of information is regarded as memory 1329. However, memory is a fungible technology and resource, thus, any number of memory embodiments may be employed in lieu of or in concert with one another. It is to be understood that the WELLNESS AD PLATFORM controller and/or a computer systemization may employ various forms of memory 1329. For example, a computer systemization may be configured wherein the operation of on-chip CPU memory (e.g., registers), RAM, ROM, and any other storage devices are provided by a paper punch tape or paper punch card mechanism; however, such an embodiment would result in an extremely slow rate of operation. In a typical configuration, memory 1329 will include ROM 1306, RAM 1305, and a storage device 1314. A storage device 1314 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 1329 may contain a collection of program and/or database components and/or data such as, but not limited to: operating system component(s) 1315 (operating system); information server component(s) 1316 (information server); user interface component(s) 1317 (user interface); Web browser component(s) 1318 (Web browser); database(s) 1319; mail server component(s) 1321; mail client component(s) 1322; cryptographic server component(s) 1320 (cryptographic server); the WELLNESS AD PLATFORM component(s) 1335; and/or the like (i.e., collectively a component collection). These components may be stored and accessed from the storage devices and/or from storage devices accessible through an interface bus. Although non-conventional program components such as those in the component collection, typically, are stored in a local storage device 1314, they may also be loaded and/or stored in memory such as: peripheral devices, RAM, remote storage facilities through a communications network, ROM, various forms of memory, and/or the like.

### Operating System

The operating system component 1315 is an executable program component facilitating the operation of the WELLNESS AD PLATFORM controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS and iOS, Microsoft Windows Mobile/NT/Vista/XP (Server)/7, Palm WebOS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the WELLNESS AD PLATFORM controller to communicate with other entities through a communications network 1313. Various communication protocols may be used by the WELLNESS AD PLATFORM controller as a subcarrier transport mechanism for interaction, such as, but not limited to: multicast, TCP/IP, UDP, unicast, and/or the like.

### Information Server

An information server component 1316 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the WELLNESS AD PLATFORM controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/mylnformation.html” portion of the request and resolve it to a location in memory containing the information “mylnformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the WELLNESS AD PLATFORM database 1319, operating systems, other program components, user interfaces, Web browsers, and/or the like.

Access to the WELLNESS AD PLATFORM database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the WELLNESS AD PLATFORM. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the WELLNESS AD PLATFORM as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows NT/XPNista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 1317 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 1318 is a stored program component that is executed by a CPU. The Web browser may be a conventional hypertext viewing application such as Microsoft Internet Explorer or Mozilla Firefox. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox's NPAPI, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly affect the obtaining and the provision of information to users, user agents, and/or the like from the WELLNESS AD PLATFORM enabled nodes. The combined application may be nugatory on systems employing standard Web browsers.

### Mail Server

A mail server component 1321 is a stored program component that is executed by a CPU 1303. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the WELLNESS AD PLATFORM.

Access to the WELLNESS AD PLATFORM mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 1322 is a stored program component that is executed by a CPU 1303. The mail client may be a conventional mail viewing application such as Apple Mail, Microsoft Entourage, Microsoft Outlook, Microsoft Outlook Express, Mozilla Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 1320 is a stored program component that is executed by a CPU 1303, cryptographic processor 1326, cryptographic processor interface 1327, cryptographic processor device 1328, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the WELLNESS AD PLATFORM may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for a digital audio file. A cryptographic component may communicate to and/or with other components in a component collection, including itself, and/or facilities of the like. The cryptographic component supports encryption schemes allowing for the secure transmission of information across a communications network to enable the WELLNESS AD PLATFORM component to engage in secure transactions if so desired. The cryptographic component facilitates the secure accessing of resources on the WELLNESS AD PLATFORM and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The WELLNESS AD PLATFORM Database

The WELLNESS AD PLATFORM database component 1319 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the WELLNESS AD PLATFORM database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the WELLNESS AD PLATFORM database is implemented as a data-structure, the use of the WELLNESS AD PLATFORM database 1319 may be integrated into another component such as the WELLNESS AD PLATFORM component 1335. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 1319 includes several tables 1319a-h. A user table 1319a includes fields such as, but not limited to: user ID, user name, and/or the like. The user table may support and/or track multiple entity accounts on a WELLNESS AD PLATFORM. An issue table 1319b includes fields such as, but not limited to: IssueID, IssueType, IssueSubType, and/or the like. An advertisement table 1319c includes fields such as, but not limited to: AdvertisementID, AdvertisementType, ContentType, MediaLink, Contribution, and/or the like. A Consumer table 1319d includes fields such as, but not limited to: ConsumerID, ConsumerName, FullName, Address, Preferences, Demographics, AdditionalProfiles, and/or the like. An advertiser table 1319e includes fields such as, but not limited to: AdvertiserID, AdvertiserName, BankAccountNumber, Campaigns, and/or the like. A Beneficiary table 1319f includes fields such as, but not limited to: BeneficiaryID, BeneficiaryName, Address, CreditAccountNumber, EntityType, WellnessType, Industry, and/or the like. A project application table 1319g includes fields such as, but not limited to: ProjectApplicationID, ProjectApplicationDate, BriefDescription, Costs, Benefits, and/or the like. An Impact table 1319h includes fields such as, but not limited to: ProjectID, AdvertisementID, RecipientID, Benefits, Amount, and/or the like.

In one embodiment, the WELLNESS AD PLATFORM database may interact with other database systems. For example, employing a distributed database system, queries and data access by search WELLNESS AD PLATFORM component may treat the combination of the WELLNESS AD PLATFORM database, an integrated data security layer database as a single database entity.

In one embodiment, user programs may contain various user interface primitives, which may serve to update the WELLNESS AD PLATFORM. Also, various accounts may require custom database tables depending upon the environments and the types of clients the WELLNESS AD PLATFORM may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 1319a-h. The WELLNESS AD PLATFORM may be configured to keep track of various settings, inputs, and parameters via database controllers.

The WELLNESS AD PLATFORM database may communicate to and/or with other components in a component collection, including itself, and/or facilities of the like. Most frequently, the WELLNESS AD PLATFORM database communicates with the WELLNESS AD PLATFORM component, other program components, and/or the like. The database may contain, retain, and provide information regarding other nodes and data.

### The WELLNESS AD PLATFORMs

The WELLNESS AD PLATFORM component 1335 is a stored program component that is executed by a CPU. In one embodiment, the WELLNESS AD PLATFORM component incorporates any and/or all combinations of the aspects of the WELLNESS AD PLATFORM that was discussed in the previous figures. As such, the WELLNESS AD PLATFORM affects accessing, obtaining and the provision of information, services, transactions, and/or the like across various communications networks.

The WELLNESS AD PLATFORM transforms wellness request, usage data, and gap financing inputs via WELLNESS AD PLATFORM components AR 1344, TBA 1345, PAA 1346, and PV 1347 into Credits, jobs, and savings outputs.

The WELLNESS AD PLATFORM component enabling access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the WELLNESS AD PLATFORM server employs a cryptographic server to encrypt and decrypt communications. The WELLNESS AD PLATFORM component may communicate to and/or with other components in a component collection, including itself, and/or facilities of the like. Most frequently, the WELLNESS AD PLATFORM component communicates with the WELLNESS AD PLATFORM database, operating systems, other program components, and/or the like. The WELLNESS AD PLATFORM may contain, communicate, generate, obtain, and/or provide program component, system, user, and/or data communications, requests, and/or responses.

### Distributed WELLNESS AD PLATFORMs

The structure and/or operation of any of the WELLNESS AD PLATFORM node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the WELLNESS AD PLATFORM controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:
w3c-post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the WELLNESS AD PLATFORM controller may be executing a PHP script implementing a Secure Sockets Layer (“SSL”) socket server via the information server, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

```
<?PHP
header(‘Content-Type: text/plain’);
// set ip address and port to listen to for incoming data
$address = ‘192.168.0.100’;
$port = 255;
// create a server-side SSL socket, listen for/accept incoming
communication
$sock = socket_create(AF_INET, SOCK_STREAM, 0);
socket_bind($sock, $address, $port) or die(‘Could not bind to address’);
socket_listen($sock);
$client = socket_accept(Ssock);
// read input data from client device in 1024 byte blocks until end of
message
do {
          $input = “”;
          $input = socket_read($client, 1024);
          $data .= $input;
} while($input != “”);
// parse data to extract variables
$obj = json_decode($data, true);
// store input data in a database
mysql_connect(″201.408.185.132″,$DBserver,$password); // access
database server
mysql_select(″CLIENT_DB.SQL″); // select database to append
mysql_query(“INSERT INTO UserTable (transmission)
VALUES ($data)”); // add data to UserTable table in a CLIENT database
mysql_close(″CLIENT_DB.SQL″); // close connection to database
?>
```

Also, the following resources may be used to provide example embodiments regarding SOAP parser implementation:

http://www.xav.com/perl/site/lib/SOAP/Parser.html
http://publib.boulder.ibm.com/infocenter/tivihelp/v2r1/index.jsp?topic=/
com.ibm.IBMDI.doc/referenceguide295.htm

and other parser implementations:

http://publib.boulder.ibm.com/infocenter/tivihelp/v2r1/index.jsp?topic=/
com.ibm.IBMDI.doc/referenceguide259.htm

all of which are hereby expressly incorporated by reference.

In order to address various issues and advance the art, the entirety of this application for APPARATUSES, METHODS AND SYSTEMS FOR A HEALTH/WELLNESS ADVERTISING, FINANCING AND MANAGEMENT PLATFORM (including the Cover Page, Title, Headings, Field, Background, Summary, Brief Description of the Drawings, Detailed Description, Claims, Abstract, Figures, Appendices, and otherwise) shows, by way of illustration, various embodiments in which the claimed innovations may be practiced. They are presented only to assist in understanding and teach the claimed principles. It should be understood that they are not representative of all claimed innovations. Thus, it is to be understood that other embodiments may be utilized and functional, logical, operational, organizational, structural and/or topological modifications may be made without departing from the scope and/or spirit of the disclosure. As such, all examples and/or embodiments are intended to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations including the right to claim such innovations, file additional applications, continuations, continuations in part, divisions, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a WELLNESS AD PLATFORM individual and/or enterprise user, database configuration and/or relational model, data type, data transmission and/or network framework, syntax structure, and/or the like, various embodiments of the WELLNESS AD PLATFORM, may be implemented that enable a great deal of flexibility and customization. While various embodiments and discussions of the WELLNESS AD PLATFORM have been directed to funding wellness projects, however, it is to be understood that the embodiments described herein may be readily configured and/or customized for a wide variety of other applications and/or implementations.

What is claimed is:

1. A processor-implemented method to facilitate matching of a wellness project with an advertisement, comprising:
obtaining via a processor wellness project application data for a wellness facilitator approved wellness project;
parsing via the processor the wellness project application data to determine project criteria associated with the wellness project;
storing via the processor the project criteria in a remotely accessible predetermined data structure to facilitate matching of the wellness project with an advertisement from an advertiser;
confirming via the processor the applicability of the project criteria;
gaining approval via the processor for the wellness project from the advertiser; and
generating a funding payment for the wellness project based on said confirming and gaining approval.

2. The method of claim 1, wherein the wellness project application data comprises a project type.

3. The method of claim 1, wherein the wellness project application data comprises a location.

4. The method of claim 1, wherein the confirming the applicability of the determined project criteria further comprises:
confirming that a project value associated with the wellness project is acceptable;
confirming that a project profile associated with the wellness project is acceptable;
confirming that a financial benefit associated with the wellness project is acceptable; and
confirming a project calculation associated with the wellness project.

5. The method of claim 2, wherein the gaining approval from the advertiser comprises determining whether the project type is acceptable to the advertiser by comparing the advertiser's project type preferences to the project type.

6. The method of claim 3, wherein the gaining approval from the advertiser comprises determining whether the location is acceptable to the advertiser by comparing the advertiser's location preferences to the location.

7. The method of claim 1, wherein the wellness project application data comprises project criteria.

8. The method of claim 7, wherein the matching comprises determining whether the project criteria are acceptable to the advertiser by comparing the advertiser's criteria preferences to the project criteria.

9. A processor-implemented method to facilitate verification of information associated with a wellness project, comprising:
retrieving via a processor wellness project data for a wellness facilitator approved wellness project at least partially funded by advertisers;
determining via the processor from the wellness project data that the wellness project should be verified;
obtaining via the processor wellness project verification data for the wellness project;
confirming via the processor the wellness project verification data;
selecting via the processor at least a portion of the wellness project verification data for auditing;
determining via the processor an auditor for the selected portion of the wellness project verification data; and
receiving via the processor a verification indication from the auditor,
wherein the wellness project is disqualified from receiving further funding from the advertisers if the verification indication indicates that the selected portion of the wellness project verification data cannot be verified.

10. The method of claim 9, wherein the confirming the wellness project verification data further comprises:
confirming that a standard associated with the wellness project is acceptable;
confirming that a calculation methodology associated with the wellness project is acceptable; and
confirming a project calculation associated with the wellness project.

11. A wellness project funding apparatus, comprising:
a memory;
a processor disposed in communication with said memory, and configured to issue a plurality of processing instructions stored in the memory, wherein the processor issues instructions to:
obtain wellness project application data for a wellness facilitator approved wellness project to be at least partially funded by advertisers;
parse the wellness project application data to determine project criteria associated with the wellness project;
store the project criteria in a remotely accessible predetermined data structure to facilitate matching of the wellness project with an advertisement from an advertiser and to facilitate verification;
obtain wellness project verification data for the wellness project;
confirm the wellness project verification data using the stored project criteria; and
receive a verification indication from an auditor for at least a portion of the confirmed wellness project verification data,
wherein processor-mediated matching of the advertisement generates gap funding for the wellness project,
wherein the wellness project is marked qualified to receive further funding from the advertisers only if the verification indication indicates that the portion of the wellness project verification data has been verified.
